(19) United States
(12) Patent Application Publication
(10) Pub. No.: US 2004/0076659 A1
(43) Pub. Date: Apr. 22, 2004

(54) Additive for livestock feeds

(75) Inventors: James A. Shelford, Vancouver (CA); George Kamande, Iowa City, IA (US); Kuo-Joan Cheng, Richmond (CA); Jose Sola, Barcelona (ES)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: The University of British Columbia

(21) Appl. No.: 10/620,299

(22) Filed: Jul. 14, 2003

Related U.S. Application Data
(63) Continuation-in-part of application No. PCT/CA02/00545, filed on Mar. 6, 2001.
(63) Continuation-in-part of application No. 09/800,601, filed on Mar. 6, 2001, now abandoned.
Application No. 09/800,601 is a continuation of application No. 09/404,971, filed on Sep. 24, 1999, now Pat. No. 6,221,381.
Application No. 09/404,971 is a continuation-in-part of application No. 09/249,662, filed on Feb. 12, 1999, now abandoned.
Application No. 09/249,662 is a continuation of application No. 08/872,654, filed on Jun. 10, 1997, now abandoned.
Application No. 08/872,654 is a continuation of application No. 08/267,596, filed on Jun. 28, 1994, now abandoned.

(51) Int. Cl. A23K 1/165; A23K 1/17

(52) U.S. Cl. 424/442

(57) ABSTRACT

Improved particulate feed additives and methods are provided for enhancing feed utilization efficiency in a ruminant animal by adding to the feed of the animals a particulate feed additive comprising a nonionic surfactant to enhance the utilization of the feed by the animal and a sufficient amount of an antioxidant agent to substantially enhance the shelf life of the feed additive. The methods and compositions result in enhanced weight gain and/or milk production by the animal.

This application is a continuation-in-part of International Application No. PCT/CA02/00545 that designates the U.S., filed Mar. 6, 2001, and a continuation-in-part of U.S. application Ser. No. 09/800,601, filed Mar. 6, 2001, which is a continuation of U.S. application Ser. No. 09/404,971, filed Sep. 24, 1999 (now U.S. Pat. No. 6,221,381), which is a continuation-in-part of U.S. application Ser. No. 09/249,662 (abandoned), which is a continuation of U.S. application Ser. No. 08/872,654, filed Jun. 10, 1997 (abandoned), which is a continuation of U.S. application Ser. No. 08/267,596, filed Jun. 28, 1994 (abandoned).

### FIELD OF THE INVENTION

The present invention relates generally to ruminant feed compositions containing nonionic surfactants, either alone or in combination with digestion enhancing agents, and to methods for enhancing feedstock utilization efficiency in ruminant livestock. In some embodiments, this invention further relates to the stabilization of nonionic surfactants in particulate or liquid ruminant feed additives.

### BACKGROUND OF THE INVENTION

Anaerobic fermentation occurs during ruminant digestion, during which proteins and carbohydrates are degraded. It is desirable in ruminant digestion to be able to control protease and carbohydrase activity to optimize the digestive process.

Since feed is a major cost in ruminant production, enhancing digestive efficiency remains a driving objective in the industry. Although forages remain the major feed source, it is widely believed that the efficiency of feed utilization by ruminants has remained relatively unchanged during the last two decades. New innovations that enhance the digestive efficiency provide a compromise to emerging environmental concerns regarding ground water pollution in most dairying areas. Nevertheless, an in depth understanding of the roles of feed processing and bacterial digestion are required to fully manipulate the digestive processes of the rumen. Cheng et al. (“Microbial ecology and physiology of feed degradation within the rumen,” in Physiological aspects of digestion and metabolism in ruminants: Proceedings of the seventh international symposium on ruminant physiology, Tsuda, Ed., 1991) has identified the following three general factors as influencing microbial digestion of feeds: (a) plant structures that regulate bacterial access to nutrients; (b) microbial factors that control adhesion and the development of digestive microbial consortia; and (c) complexes of oriented hydrolytic enzymes of the adherent microorganisms. Feed processing practices, e.g., grinding, normally attempt to increase enzyme-substrate interaction by the exposition of susceptible substrate binding sites.

The manipulation of digestion within the rumen in order to increase the efficiency of feed utilization has been achieved through the use of exogenous enzymes (Feng et al., “Effect of enzyme additives on in situ and in vitro degradation of mature cool-season grass forage,” J. Anim. Sci. 70 (Suppl. 1):309 (1996)), and such compounds as ionophore antibiotics, methane production inhibitors, inhibitors of proteolysis or deamination, and buffers (Jouany, “Methods of manipulating the microbial metabolism in the rumen,” Ann. Zootech. 43:49-62 (1994)). The increased digestive efficiency realized through the use of these compounds is the result of major shifts in microbial fermentation pathways. For example, the selective use of antibiotics can alter the rumen microbial population and ultimately influence the end products of digestion. Antibiotics are, however, used only in meat producing animals because of the risk of antibiotic transfer to milk. Production responses of animals fed exogenous enzymes have been inconsistent. Exogenous enzymes have been shown to increase. (Beauchemin et al., “Fibrolytic enzymes increase fiber digestibility and growth rate of steers fed dry forages,” Can. J Anim. Sci. 75:641-644 (1995)), to not affect (Perry et al., “Effects of supplemental enzymes on nitrogen balance, digestibility of energy and nutrients and on growth and feed efficiency of cattle,” J. Anim. Sci. 25:760-764 (1966)), and even to decrease (Svozil et al., “Application of a cellulolytic preparation in nutrition of lambs” Sbor. Ved. Praci. VUVZ Prhrelice 22:69-78 (1989)) the growth performance of ruminants fed forage or concentrate-based diets. The inconsistency is partly due to the numerous enzyme preparations available, application methods, and their interaction with different types of diets.

Long-chain fatty acids and the halogen homologues of methane have been found to reduce methane production in the rumen (Van Nevel et al., “Manipulation of rumen fermentation,” In: The Rumen Microbial Ecosystem., Ed. P. N. Hobson. Elsevier Applied Science, London, pp. 387 et seq. (1988)). The reduction in methane production is usually associated with a decrease in deamination of amino acids, particularly, branched-chain amino acids and an increase in propionic acid production. The main limitation with the use of these additives is that rumen microbes are able to adapt and degrade them after about one month of treatment. Another disadvantage is that the beneficial effect appears to be consistent only in forage-based diets that favor methane production.

Buffers are mainly used under conditions where the feeding of high levels of grains can induce an active fermentation and cause excess production of acids within the rumen. They act by regulating and maintaining the pH at levels at which the cellulolytic microorganisms can be of maximum effectiveness (pH=6-7). The digestion of starch and proteins is generally decreased when buffers are fed, however, the effect on the digestion of cell wall carbohydrates is inconsistent (Jouany, “Methods of manipulating the microbial metabolism in the rumen,” Ann. Zootech. 43:49-62 (1994)).

Surfactants have been used in the food processing industry as emulsifiers and extenders (Griffin et al., “Surface Active Agents,” in Handbook of Food Additives. 2^{nd} Ed., T. E. Furia, Ed., CRC Press, New York, N.Y., p 397 et seq. (1972)) and also as cleaning agents. The most well known physicochemical property of surfactants is their interfacial activity when placed in solution. Their ability to align at the interfaces is a reflection of their tendency to assume the most energetically stable orientation. One type of nonionic surfactant, the polyoxyethylene sorbitan esters, is synthesized by the addition, via polymerization, of ethylene oxide to sorbitan fatty acid esters. These nonionic hydrophilic emulsifiers are very effective antistaling agents and are therefore used in a variety of bakery products. They are widely known as polysorbates. The effects of the polysorbate Tween 80 on the hydrolysis of newspaper was investigated by Castanon et al., “Effects of the surfactant Tween 80 on enzymatic hydrolysis of newspaper,” Biotechnol. & Bioeng. 23:1365 (1981). However, the effects of nonionic surfactants on ruminant digestion have not heretofore been contemplated.

Shelford et al., in related U.S. Pat. No. 6,221,381 issued Apr. 24, 2001, disclose that when nonionic surfactants are admixed in ruminant feedstuffs at a concentration of from about 0.01 to 1% (w/w) and the feedstuffs are fed to ruminants, significantly higher productivity can be expected from these animals. Higher productivity may be characterized by higher milk yield, increased rate of weight gain, higher efficiency in converting feed into body tissues or milk, and/or a reduction in manure production. This patent further discloses that when nonionic surfactants at a concentration of from about 0.01 to 1% (w/w) are combined with digestive enzymes, such as glycanases, and admixed with ruminant feeds, ruminant animals consuming said feed have higher feed conversion efficiencies and productivity.

In one embodiment of U.S. Pat. No. 6,221,381, the nonionic surfactant is coated on a carrier such as celite, diatomaceous earth, or silica and admixed with the feed before feeding the feed to the animal. The surfactant coats the surface of the carrier to enhance attachment of enzymes and or bacteria once the animal consumes the feed material. In other embodiments, the nonionic surfactant is provided in liquid form for application to animal feed.

The methods and compositions of U.S. Pat. No. 6,221,381 have been found to result in substantial enhancements in milk production in dairy herds and substantial enhancements in weight gain in feedlot cattle, whether the nonionic surfactant is administered as a coating on a carrier or in liquid form. It has now been further discovered that liquid nonionic surfactant materials containing unsaturated fatty acid chains are subject to rapid surfactant degradation and rancidity development. Thus, in one embodiment, the present invention provides feed additives for ruminant animals and methods for enhancing feedstock utilization efficiency in livestock by adding to the fee of the animals a nonionic surfactant. In other embodiments, the present invention provides improved compositions and methods that utilize stabilized nonionic surfactants to substantially extend the shelf life of surfactant-containing liquid feed additives and surfactant coated, particulate feed enhancing compositions. The compositions and methods described in this invention optimize the digestive process in ruminant animals, enhance productivity of ruminant animals, reduce waste production and ultimately improve profitability.

### SUMMARY OF THE INVENTION

The present invention provides new and surprising methods and compositions for enhancing feed utilization efficiency in ruminant animals, such as cattle, sheep, goats, deer, bison, water buffalo and camels. In one aspect of the invention, a sufficient amount of a nonionic surfactant is added to the feed of a ruminant animal in either liquid or particulate form, to enhance the utilization of the feed by the animal. In particular, it has now discovered that when nonionic surfactants are admixed in ruminant feedstuffs at a concentration of from about 0.01 to 1% (w/w) based on the weight of the feedstuffs, and the feedstuffs are fed to ruminants, significantly higher productivity can be expected from these animals. In other aspects, antioxidant materials may be added to the nonionic surfactants of liquid or particulate feed additives to obtain an improved feed additive product that exhibits a substantially extended shelf life. The improved liquid or particulate feed additive product may then be admixed in ruminant feedstuffs in amounts ranging from about 20 to about 60 g/cow/day for liquid feed additives of the invention and in amounts ranging from about 40 to about 120 g/cow/day for particulate feed additives, resulting in significantly higher productivity from these animals. Higher productivity may be characterized by higher milk yield, increased rate of weight gain, higher efficiency in converting feed into body tissues or milk, and/or a reduction in manure production. It has also been discovered that when the stabilized nonionic surfactants at a concentration of from about 0.01 to 1% (w/w) based on the ratio of the weight of the surfactant in the feed additive to the weight of the feedstuffs fed to ruminants are combined with digestive enzymes, such as glycanases, and admixed with ruminant feeds, ruminant animals consuming said feed have higher feed conversion efficiencies and productivity.

In other aspects, the present invention provides compositions and methods that modify fermentation within the rumen towards more propionic acid production at the expense of acetic acid. Less heat is produced during the metabolism of propionic acid in the animal compared to that produced during the metabolism of acetic acid. Therefore the methods and compositions of the invention may be used to mitigate the effect of heat stress in ruminant animals.

In yet other aspects, the present invention provides methods for incorporating surfactant into ruminant feedstuff that ensures even distribution of the surfactant in the feedstuffs in order to obtain consistent improvement in animal performance. This aspect of the invention extends to feed additives containing nonionic surfactants either alone or in combination with digestion enhancing agents in concentrations as specified in the present invention.

In one preferred embodiment of the present invention, a nonionic surfactant is diluted with water or a carrier such as celite, diatomaceous earth, or silica and admixed with the feed before feeding the feed to the animal. When diluted with water, the surfactant may be sprayed onto the feed while the feed is simultaneously being mixed to ensure even distribution of the surfactant in the entire feed material. The surfactant coats the surface of the feed to enhance attachment of enzymes and or bacteria once the animal consumes the feed material.

In other aspects, a nonionic surfactant is applied to animal feed in liquid form, or is coated onto a particulate carrier, such as celite, diatomaceous earth, or silica to form a particulate feed additive material. In another embodiment of the present invention, a nonionic surfactant is mixed with a suitable antioxidant agent and then applied in liquid form to animal feed or is coated onto a particulate carrier such as celite, diatomaceous earth, or silica to form a particulate feed additive material. The feed additive may then be admixed with animal feed before feeding the feed to an animal. Mixing of the coated particles with the feed ensures even distribution of the surfactant in the entire feed material, to enhance attachment of enzymes and or bacteria once the animal consumes the feed material, while inclusion of an antioxidant in the coating substantially enhances the shelf life of the particulate feed additive product.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a graphical representation of the effect of the nonionic surfactants polyoxyethylenesorbitan monooleate (Tween 60, shown as “●” for protease activation (left axis) and “▪” for SH unmasking (right axis)), and polyoxyethylenesorbitan trioleate (Tween 80, shown as “♦” for protease activation (left axis) and “▴” for SH unmasking (right axis)) as described in Example 2;

FIG. 2 is a graphical representation of the effect of the nonionic surfactants Tween 60 (“▪” and Tween 80 (▴) compared to control (“♦”) on in vitro cellulose degradation as described in Example 2;

FIG. 3 is a graphical representation of the effect of the nonionic surfactant Tween 80 on milk production in dairy cows as described in Example 4. In FIG. 3, ♦ represents the control, ▪ represents Tween 80 at a concentration of 0.2% w/w plus 0.1% enzyme, and ▴ represents Tween 80 at a concentration of 0.2% w/w;

FIG. 4 is a graphical representation of the effect of the nonionic surfactant Tween 80 on milk production in mature dairy cows as described in Example 4. In FIG. 4, ♦ represents the control, ▪ represents Tween 80 at a concentration of 0.2% w/w plus 0.1% enzyme, and ▴ represents Tween 80 at a concentration of 0.2% w/w;

FIG. 5 is a graphical representation of the effect of the nonionic surfactant Tween:80 on milk production in heifers as described in Example 4. In FIG. 5, ♦ represents the control, ▪ represents Tween 80 at a concentration of 0.2% w/w plus 0.1% enzyme, and ▴ represents Tween 80 at a concentration of 0.2% w/w;

FIG. 6 is a graphical representation of the effect of the nonionic surfactant Tween 80 on milk production in fresh cows as described in Example 4. In FIG. 6, ♦ represents the control, ▪ represents Tween 80 at a concentration of 0.2% w/w plus 0.1% enzyme, and ▴ represents Tween 80 at a concentration of 0.2% w/w;

FIG. 7 is a graphical representation of the effect of the nonionic surfactant Tween 80 at 0.2% (w/w) and 0.3% (w/w) concentration levels on milk production in dairy cows as described in Example 5. In FIG. 7, ♦ represents the control, ▪ represents Tween 80 at a concentration of 0.2% w/w plus 0.1% enzyme, and ▴ represents Tween 80 at a concentration of 0.2% w/w;

FIG. 8 is a graphical representation of the effect of the nonionic surfactant Tween 80 at 0.2% (w/w) and 0.3% (w/w) concentration levels on milk production in first calf heifers as described in Example 5. In FIG. 8, ♦ represents the control, ▪ represents Tween 80 at a concentration of 0.2% w/w, and ▴ represents Tween 80 at a concentration of 0.3% w/w;

FIG. 9 is a graphical representation of the effect of the nonionic surfactant Tween 80 at 0.2% (w/w) and 0.3% (w/w) concentrations levels on milk production in mature cows as described in Example 5. In FIG. 9, ♦ represents the control, ▪ represents Tween 80 at a concentration of 0.2% w/w, and ▴ represents Tween 80 at a concentration of 0.3% w/w.

### DETAILED DESCRIPTION OF THE PREFERRED EMBODIMENT

According to one aspect of the present invention, methods and compositions are provided for enhancing feed utilization efficiency in ruminant animals, comprising adding to the feed of the animals a sufficient amount of a nonionic surfactant, in liquid form or coated on a particulate carrier, to enhance the utilization of the feed by the animal. In other aspects, methods and compositions are provided for enhancing feed utilization efficiency in ruminant animals, comprising adding to the feed of the animals a sufficient amount of a nonionic surfactant coated particulate feed additive to enhance the utilization of the feed by the animal. The liquid and particulate feed additive coating of the invention may further comprise, in addition to the surfactant, a sufficient amount of an antioxidant material to substantially increase the shelf life of the particulate feed additive.

The term “feed efficiency” or “feed utilization” or “feed conversion” as used herein means the amount of feed needed to obtain a given amount of weight gain or milk production. In particular, feed efficiency or utilization expresses the efficiency by which an animal converts feed into weight gain or milk production. Feed efficiency is expressed as the ratio of weight of feed to weight gain (or milk production).

Although the terms “feed efficiency” and “weight gain” are often used together, there is a significant difference between the two as can be seen by the above definitions. Specifically, the determination of feed efficiency depends upon a given weight gain or milk production whereas the determination of weight gain or absolute milk production does not depend upon a given feed efficiency. The differences are especially significant to an animal producer or dairy farmer. In particular, weight gain or milk production can be achieved with little, no or even negative change in feed efficiency. Thus, for the animal producer, merely obtaining increases in weight gain or milk production may not necessarily be a more cost effective method for growth of the animal. While a producer looks at numerous factors in determining the cost of production, feed utilization efficiency is probably the most important and has the most impact on cost per pound of meat produced.

Thus, in one aspect of the invention, methods and compositions are provided for enhancing weight gain in a ruminant animal for a given amount of animal feed, comprising adding to the feed a sufficient amount of a nonionic surfactant to enhance the weight gain by the animal. In this aspect of the invention, new liquid and particulate feed additives and methods are provided for enhancing weight gain in a ruminant animal for a given amount of animal feed, comprising adding to the feed a sufficient amount of a liquid or particulate feed additive to enhance the weight gain by the animal, wherein the liquid or particulate feed additive comprises a nonionic surfactant and, in some embodiments, an antioxidant agent. In yet other aspects of the invention, methods and compositions are provided for enhancing milk production by a ruminant animal, comprising adding to the feed of the animal a sufficient amount of a liquid or particulate feed additive to enhance milk production by the animal, wherein the particulate feed additive comprises a nonionic surfactant and, in some embodiments, an antioxidant agent. In still other aspects of the invention, methods and compositions are provided for reducing the adverse effects of heat stress in a ruminant animal, comprising adding to the feed of the animal a sufficient amount of a nonionic surfactant to enhance feed utilization efficiency, enhance weight gain and/or enhance milk production by the animal.

In another aspect of the invention, new liquid feed additives and methods are provided for enhancing weight gain in a ruminant animal for a given amount of animal feed, comprising adding to the feed a sufficient amount of a liquid feed additive to enhance the weight gain by the animal, wherein the feed additive comprises a nonionic surfactant and, in some embodiments, an antioxidant agent. In yet other aspects of the invention, methods and compositions are provided for enhancing milk production by a ruminant animal, comprising adding to the feed of the animal a sufficient amount of a liquid feed additive to enhance milk production by the animal, wherein the feed additive comprises a nonionic surfactant and, in some embodiments, an antioxidant agent. In still other aspects of the invention, methods and compositions are provided for reducing the adverse effects of heat stress in a ruminant animal, comprising adding to the feed of the animal a sufficient amount of a nonionic surfactant to enhance feed utilization efficiency, enhance weight gain and/or enhance milk production by the animal.

As used herein, the term “ruminant” means an even-toed hoofed animal which has a complex 3- or 4-chambered stomach, and which is characterized by chewing again what it has already swallowed. Some examples of ruminants include cattle, sheep, goats, deer, bison, water buffalo and camels.

As used herein, “surfactant(s)” include surface active agents that are organic or organic-metal molecules that exhibit polar and solubility behavior that result in the phenomenon known as surface activity. The most commonly recognized phenomenon in this respect is the reduction of the boundary between two immiscible fluids. Surfactants include surface active agents, which act as emulsifiers, wetting agents, solubilizers, detergents, suspending agents, crystallization modifiers (both aqueous and non aqueous), complexing agents and in other ways. The surfactants most useful in the practice of the present invention are the nonionic surfactants, including, without limitation, polyoxyethylenesorbitan monooleate (Tween 60), polyoxyethylenesorbitan trioleate (Tween 80), polyoxyethylenesorbitan monostearate, alkyltrimethylammonium bromides, dodecyltrimethylammonium bromide, hexadecyltrimethylammonium bromide, mixed alkyltrimethylammonium bromide, tetradecyltrimethylammonium bromide, benzalkonium chloride, benzethonium chloride, benzyldimethyldodecylammonium bromide, benzyldimethylhexadecylammonium bromide, benzyltrimethylammonium chloride, benzyltrimethylammonium methoxide, cetylpyridinium bromide, cetylpyridinium chloride, cetyltributylphosphonium bromide, cetyltrimethylammonium bromide, decamethonium bromide, dimethyldioctadecylammonium bromide, methylbenzethonium chloride, methyl mixed trialkyl ammonium chloride, methyltrioctylammonium chloride, n,n′,mb′-polyethylene(10)-n-tallow-1,3-diamino-propane and 4-picoline dodecyl sulfate. In the most preferred form of the invention, the nonionic surfactant is selected from the group consisting of polyoxyethylenesorbitan monooleate (Tween 60) and polyoxyethylenesorbitan trioleate (Tween 80).

The concentration of surfactant affects the physical and chemical properties of the surface of feed particles, and consequently, digestion of the feed particle. During our earlier investigations, we determined that the range of concentrations of surfactants that promote association of enzymes with feed particles is quite narrow. Insufficient concentrations of surfactant did not increase interaction between enzymes and feed particles, whereas excess amounts tended to mask the surface of the feed particles and impede enzyme attachment. For purposes of the present invention, effective amounts of nonionic surfactants and their derivatives are from about 0.01 to 1% (w/w) of the dry weight of the feed, preferably from 0.01 to 0.5% (w/w) of the dry weight of the feed, and most preferably from 0.01 to 0.3% (w/w) of the dry weight of the feed.

For purposes of the present invention, the term “antioxidant agent” includes antioxidant compounds that are compatible with and suitable for use in animal feeds. Useful antioxidant agents include, for example, butylated hydroxyanisole (BHA), butylated hydroxytoluene (BHT), ethoxyquin, propyl gallate, tertiary butyl hydroquinone (TBHQ), tocopherols and the like. The antioxidant agents will generally be employed in the particulate feed additive coatings of the invention in amounts effective to substantially increase the shelf life of the feed additives, such as by substantially reducing the rate of rancidity conversion in the surfactant materials of the invention. Useful amounts of the antioxidant agents will generally range from about 50 to about 5000 ppm, more preferably from about 100 to about 2000 ppm, and most preferably from about 200 to about 1000 ppm, based on the surfactant solution employed to coat the particulate feed additive material.

In one presently preferred embodiment of this invention, the nonionic surfactant is diluted with a suitable diluent that does not affect the physico-chemical properties of surfactant before admixing with feed for ease of application and to ensure that the surfactant is distributed evenly in the feed. Suitable diluents include, but are not limited to water, celite, diatomaceous earth, and silica.

Thus, in one embodiment of the invention, the surfactant and antioxidant agents of the invention are with mixed a particulate carrier substrate so that a coating is formed on the carrier substrate comprising about 10% to about 70% (wt/wt), more preferably about 20% to about 65% (wt/wt) and most preferably about 40% to about 60% (wt/wt) of surfactant based on the combined weight of the particulate carrier material and coating. A particularly useful amount of surfactant/antioxidant coating material is about 50% (wt/wt) based on the combined weight of the coated product. Particulate carrier materials useful as a substrate for the surfactant/antioxidant coating of the invention include substantially inert particulate carrier materials that are suitable for feed additive applications. Suitable particulate carrier materials include, but are not limited to celite, diatomaceous earth, and silica. Specific, non-limiting examples of useful carriers include, for example, celite (Fisher Scientific Co., New Jersey, USA), diatomaceous earth (Sigma Chemical Co. St. Louis, Mo.) and LuctaCarrierm silica (Lucta, S. A., Barcelona, Spain).

The coated particulate feed additive of the invention formed as described above may be added to animal feed in an amount sufficient to enhance feed utilization efficiency in the animals. For purposes of the present invention, effective amounts of the particulate feed additive, when mixed with the animal feed, will typically be about 40 to about 120 g of the particulate feed additive per cow per day, more preferably from about 60 to about 100 g of the particulate feed additive per cow per day. Effective amounts of the liquid feed additives of the invention, when mixed with the animal feed, will typically be about 20 to about 60 g of the liquid feed additive per cow per day, more preferably from about 30 to about 50 g of the liquid feed additive per cow per day.

Feedstuff or feed useful in the practice of the present invention includes forages and grain feeds, such as grass and legume forages, crop residues, cereal grains, legume by-products and other agricultural by-products. In situations where the resulting feed is to be processed or preserved, the feed may be treated with the surfactant and/or enzyme before processing or preservation. Processing may include drying, ensiling, chopping, pelleting, cubing or baling in the case of forages, and in the case of grains and legume seeds by rolling, tempering, grinding, cracking, popping, extruding, pelleting, cubing, micronizing, roasting, flaking, cooking and or exploding.

As used herein, “forages” include the cut aerial portion of a plant material, both monocotyledonous and dicotyledonous, used as animal feed. Examples include, without limitation, orchard grass, timothy, tall fescue, ryegrass, alfalfa, sainfoin, clovers and vetches.

As used herein, “grain feeds,” means the seeds of plants that are fed to ruminant animals and may or may not include the outer hull, pod or husk of the seed. Examples include, without limitation, corn, wheat, barley sorghum, triticale, rye, canola, and Soya beans.

The present invention may be combined with other feed processing techniques or preservation methods, and may be included either during processing or preservation. Other processing techniques useful in combination with the present invention include, but not limited to, drying, ensiling, chopping, grinding, pelleting, cubing or baling in the case of forages, and in the case of grains feeds and legume seeds by drying, rolling, tempering, grinding, cracking, popping, extruding, pelleting, cubing, micronizing, roasting, flaking, cooking and or exploding. Preservation may include, but not limited to ensiling and haymaking.

Surfactants and enzymes used in accordance with the present invention are available in either a liquid or powdered form. If a liquid is used, the surfactant may be sprayed “as is” onto the feed material or preferably diluted in the same or separate aqueous solutions before application. When provided as a nonionic surfactant coated on a solid, the surfactant preferably may constitute at least 50% of the dry weight of the product. If provided as a solid it may be applied to the feed material “as is” or preferably dissolved in water or aqueous solutions such as a buffer solution with a pH range from 4.5 to 7 before application. The improved particulate feed additive of the invention is preferably evenly applied to the feed material. The resulting feed can either be fed immediately to livestock or stored and fed at a later time. The resulting feed composition is effective for prolonged periods of time, such as for at least three years or longer depending on the nature of the feed composition, storage conditions and the like.

In addition to feed and the particulate or liquid feed additive described above, the compositions of the invention may further comprise one or more additional agents that enhance the ruminant digestive processes. Such agents include, for example, pyrodoxal 5-phosphate, fumaric acid and its salts, sorbic acid and its salts, parabenzoic acid esters, benzoic acid, polydimethyl siloxane-polyethers, unsaturated alcohols, bentonite, proteolytic and/or carbohydrase enzymes, such as glycanase, hemicellase, cellulase, pectinase, xylanase and amylase, lactic acid bacteria inoculants, such as those comprising Lactobacillus casei, L. acidophilus, L. salivarius, L. corymiformis subsp coryniformis, L. curvatus, L. plantarum, L. brevis, L. buchner, L. fermentum, L. viridescens, Pdiococcus acidilacti, P. cerevisiae, P. pentosaceus, Streptococcus faecalis, S. faecium, S. lactis, L. buchneri, L. fermentum, L. viridenscens, L. delbrueckiin, Leuconostoc cremoris, L. dextranicum, L. mesenteroides or L. citrovorum, and polyether carboxylic acid ionophore antibiotics, such as monensin (see, e.g., Westley, Adv. Appl. Microbiology 22:177-223 (1977)). Where the surfactant is used in conjunction with exogenous glycanases, the method of producing feed compositions in the present invention is most effective when surfactant constitute on the order of about 0.01% of the dry weight of the feed. In situations where the surfactant is used without exogenous enzymes, the compositions are most effective when the surfactant concentration does not exceed about 0.2% of the dry weight of the feed.

### EXAMPLE 1

### Protease Activity and Adsorption

Animals Feed and Rumen Fluid Collection

Two rumen-fistulated, nonlactating cows averaging 623±12.5 kg in weight were fed 5 kg dry matter (DM) of low quality timothy hay twice daily. About 2.5L of rumen fluid was collected through the fistula 4 hrs after the morning feeding at 07:00 hrs. Bulk feed particles were removed by sieving the fluid through a 0.5 mm strain. The fluid was then composited and then stored in a prewarmed (37° C.) thermal container.

Preparation of Rumen Mixed Microbial Cell and Enzyme Source

A microbial powder was prepared using the acetone-butanol extraction procedure outlined by Mahadevan et al., “Preparation of protease from mixed rumen microorganisms and its use for the in vitro determination of true protein in feedstuffs,” Can. J. Anim. Sci. 67:55 (1987). About 500 g of this powder was prepared and stored at −20° C. Extraction of the proteases was accomplished by stirring 250 g of the powder with 1L of 4° C. cold water (for 1 hr) and then proceeding along Mahadevan's extraction procedure. Only extracts from the filtration with an XM-300 Amicon Filter, (approx. 300 000 molecular weight cutoff—under nitrogen gas), were made, washed twice with distilled water and the retentate freeze dried. This was referred to as the mixed microbial cell enzyme source. It was used in the protein adhesion tests and also in the parallel thiol and protease activity determinations.

Determination of Thiols and Protease Activity, and Bacterial Protein Adhesion

Ten grams of the mixed microbial cell enzyme was dissolved in 100 ml warm (37° C.) 0.1 M phosphate buffer, pH 6.8, and used as an enzyme inoculant. The assay matrix consisted of 1 ml enzyme source, 1 ml 2% casein solution, 1 ml 01 M phosphate buffer and 1 ml of either the relevant level of surfactant or an equivalent amount of buffer. Ten levels of the two surfactants, polyoxyethylene sorbitan monoleate (Tween 80) and polyoxyethylene sorbitan monastearate (Tween 60) were tested, viz 0, 0.08, 0.16, 0.24, 0.32, 0.4, 0.8, 1.2, 1.6, and, 2.0% surfactant in the assay mixture.

The protease activity incubations were performed in 50 ml plastic centrifuge tubes, at 37° C. and under a stream of carbon dioxide gas. After 1.5 hr, 1 ml of the assay mixture was removed for the determination of thiols (SH) and disulfides (SS) (Sasago et al., “Determination of sulfhydryl and disulfide groups in milk by p-chloromercuribenzoate-diathizone method,” J. Dairy Sci. 46:1348-1351 (1963)). At the end of 2 hr incubation, the reaction was stopped with 1 ml of 15% TCA (trichloroacetic acid) solution, cooled to 4° C. under an icebath, and centrifuged at 10,000 for 10 min. The free amino acids in the supernatant were assayed using the ninhydrin method (Rosen, “a Modified Colorimetric Analysis For Amino Acids,” Arch. Biochim. Biophys. 67:10 (1957)). The optimal surfactant inclusion level was calculated by direct linear plots on the assumption that the Michaellis-Menten equation applied.

For the cellulose adhesion tests, the microbial enzyme source was resuspended and tested for adhesion on to a cellulose. substrate (barley straw, with 4% CP and ground through 0.5 mm sieve). Microbial adsorption was demonstrated by stirring, (120 strokes/min) at 30° C. 0.1 g of the straw in 5 ml of a bacterial cell-enzyme inoculum suspension, and then following the supernatant protein change with time. Readings were taken at 10, 20, 30, 60, and 120 min. At the end of the adsorption period, the assay contents were centrifuged at 2500 g max for 10 min to precipitate the solids, and the protein in the supernatant was precipitated out by 15% TCA solution and quantified by the Bicichoninic method (Smith et al., “Measurement of protein using bicinchonic acid,” Anal. Biochem. 150:76 (1984)). The mother suspension contained 4.0 g of the lyophilized mixed bacteria and enzyme in 400 ml of 0.1 M phosphate buffer pH 6.8, with the following levels of surfactant (Tween-80); 0, 0.1, 0.25, and 0.5%.

### EXAMPLE 2

### In Vitro Protein and Cellulose Degradation

Preparation of Rumen Fluid Inoculum

A bacterial fraction, largely free of protozoa, was prepared for the fermentation assays by using the procedure of Forsberg, “Some Effects of Arsenic on the Rumen Microflora; An In Vitro Study,” Can. J. Microbiol. 24:36 (1978). The digesta inoculum was resuspended and washed twice in an equivalent amount of 0.1 M phosphate buffer pH 6.8 to the rumen fluid. The inoculum provided both, the substrate and the enzyme used for cellulose degradation assay. Incubation periods were 0, 1.5, 3, 6, 12, 24, and 48 hr. Other incubation conditions were similar to those outlined in experiment 1 above. However, cellulose was determined by the method of Updergraff, supra, for the in vivo digestibility trial. The optimal level of Tween 80 obtained was adopted here and followed.

In Vivo Digestibility Trial

Four wethers weighing (72.5±15.0 kg) fitted with both rumen and duodenal cannula, were offered chopped medium quality timothy hay ad libitum. The hay was either sprayed with 500 ml water or 50 ml of Tween 0.80 dissolved in 500 ml of water. The feed was offered in two equal portions, at 08:30 and 20:30 hr. Water was available ad libitum. The experiment was designed as a 2×2 latin square with two 14-day adaptation, two 7-day collection periods.

Estimates of the rates of passage of the two treated hays were made using chromium mordanted fibre (Cr) for the particulate phase and cobalt-ethylene diaminetetracetic acid (Co-EDTA) for the liquid phase. The method of Uden et al., “Investigation of chromium, cerium and cobalt as markers in digesta: Rate of Passage studies,” J. Sci. of Food and Agriculture 31:625-632 (1980), was used in the preparation of both markers.

The sheep were adapted to the feed in individual pens, and then moved into digestibility cages for total collection and marker infusion. During the collection period, records of feed intake, faecal and urine output were maintained. 250 g subsamples of the faeces were collected daily, subsampled for DM determination, while the rest was dried under a drought oven. Urine was collected under 1N sulphuric acid.

On the last day of the collection period, each sheep was given 50 g of Cr-mordanted fibre 1 hr prior to the evening feeding. In addition, 250 ml of Co-EDTA (0.1 g/ml) was infused intraruminally and the animals were then fed. Rumen digesta and duodenal sampling commenced 4 hr after dosing and continued at the same interval for 96 hr.

Two samples of rumen fluid were collected: The first rumen fluid samples (30 ml) were preserved for microbial protein estimations by adding 7.5 ml of 0.9% NaCl in 37% formaldehyde solution. The samples were then stored at −20° C. after the preparation of a bacterial pellet by centrifugation at 27,000 g max for 15 min. A portion of the second rumen fluid and faecal samples was dried at 80° C. and ground in a coffee grinder (Braun, Inc. MA) for DM and Cr determination (Uden et al., 1980). Cr concentration in the samples was determined in duplicate by atomic absorption spectrophotometer (Perkin Elmer 560) using Cr standards (Fisher Scientific Co. NJ). The rest of the second rumen fluid sample was centrifuged at 10,000 g max for 10 min and the supernatants analyzed directly for cobalt using 0.1N HCL as the blank. Standards were prepared using cobalt chloride (Fisher Scientific Co. NJ). Marker concentrations were expressed per gram of dry sample.

Other analyses included: acid and neutral detergent fibre (Goering and Van Soest, “Forage fiber analysis,” Agric. Handbook No. 379, p. 12 (1970)), total N (Parkinson and Allen, “A wet oxidation procedure suitable for the determination of nitrogen and mineral nutrients in biological materials,” Comm. Soil Sci. Plant Anal. 6:1 (1975)) for RNA concentrations of the rumen bacterial pellets and duodenal samples.

Results

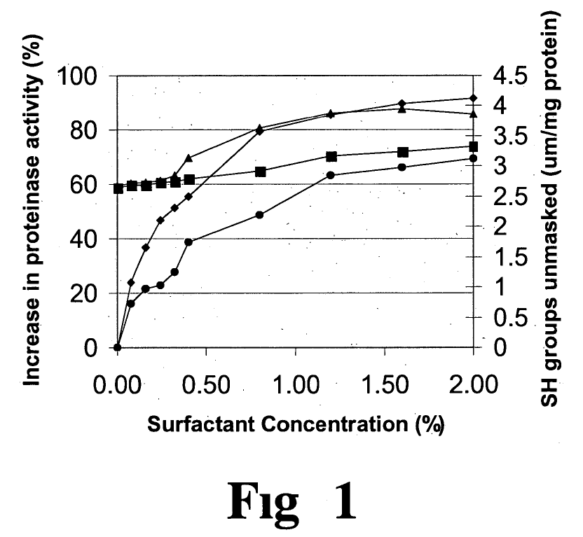

FIG. 1 shows the effect of Tween 60 and 80 on the activation of rumen microbial proteinases and the unmasking of the reactive cysteine (SH) groups. The initial rates of proteinase activation were, 163.5% (s.e. 14.69) and 98.04% (s.e. 0.13) control=0. The optimal surfactant inclusion level was calculated by direct linear plots on the assumption that the Michaelis-Menten equation applies. The concentration of additive required to achieve half the maximum velocity of the rumen enzyme, provided that the protein substrates were at saturating concentrations is given by the Km value. Vmax values represent the velocity of the enzyme reaction when all substrates are at saturating concentrations. The protease activation rate (Vmax) due to Tween 80 was significantly higher than that of Tween 60 (Table 1). Further the concentration (Km) of Tween 80 required to elucidate this effect was also significantly lower than in Tween 60.

TABLE 1
The apparent coefficients of proteinase activation and SH unmasking

| | Km¹ | Vmax² |
|---|---|---|
| Proteinase activation | | |
| Tween 60 | 0.28 ± 0.02a | 99.2 ± 2.7a |
| Tween 80 | 0.20 ± 0.03b | 166.8 ± 8.9b |

Max. rate
(μmol SH/mg protein/
% change in surfactant

| | |
|---|---|
| SH unmasking | |
| Tween 60 | 0.30 ± 0.03a |
| Tween 80 | 0.98 ± 0.29b |

Column values followed by similar letters are not significantly different (P<0.05). ¹Additive conc. (%). ²Maximum proteinase activation (%/unit additive conc.).

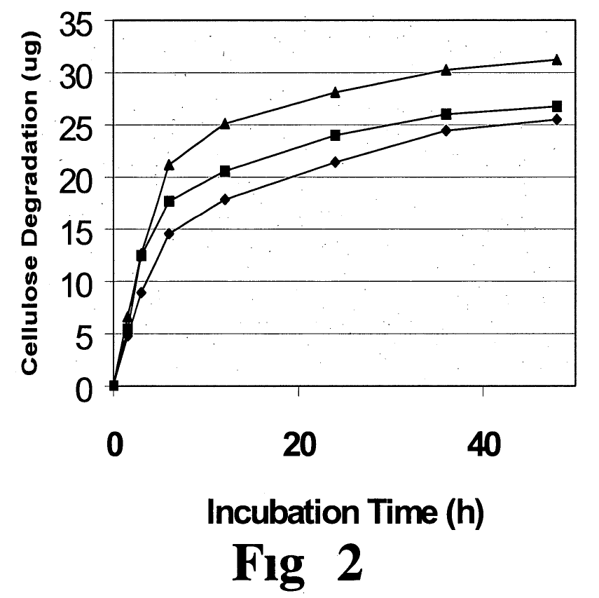

The effect of either Tween 60 or 80 on rumen cellulase activity is depicted in FIG. 2. 0.25% of either surfactant was used in the reaction mixture, based on the results in Table 1, (approximately Km value). The rates of cellulose breakdown calculated by regression analysis on the initial 24 hr incubation period are shown in Table 2. The results show that the addition of either surfactant increased the rate of cellulose breakdown significantly (P<0.05).

TABLE 2
Initial rates of cellulose degradation.

| Treatment | rate (μg/ml/hr) |
|---|---|
| no additive | 0.60a (0.21) |
| Tween 60 | 0.87b (0.28) |
| Tween 80 | 1.04c (0.32) |

Column values followed by similar letters are not significantly different (P<0.05). Bracketed values are standard errors.

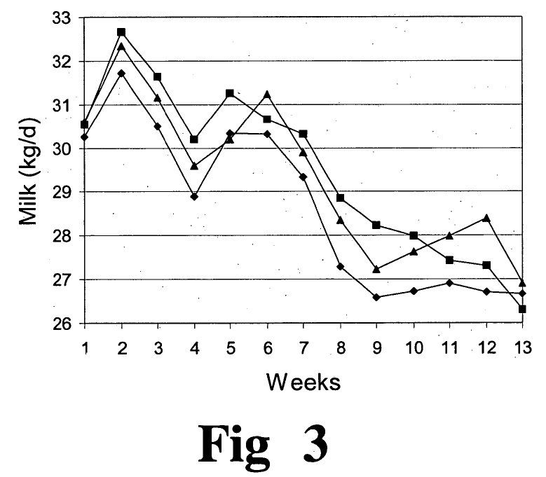

FIG. 3 shows the effect of Tween 80 on rumen microbial cells enzyme source adsorption to barley straw over time. The addition of Tween 80 significantly (P<0.05) increased microbial protein adsorption levels greater than 0.1% did not alter either the rate or the extent of adsorption significantly (P<0.05), (Table 3). The effect of Tween 60 on microbial protein adsorption to ground straw was not determined.

TABLE 3
Coefficients of microbial protein adsorption to cereal straw

Microbial protein adsorption

| Additive level (%) | rate (μg/mg/min) | extent (μg/mg) |
|---|---|---|
| no additive | 0.026a (0.03) | 0.94a |
| 0.05% Tween 80 | 0.032b (0.01) | 1.12b |
| 0.10% Tween 80 | 0.034c (0.02) | 1.21c |
| 0.25% Tween 80 | 0.035c (0.01) | 1.18c |
| 0.50% Tween 80 | 0.034c (0.02) | 1.19c |

Column values followed by similar letters are not significantly different (P<0.05). Bracketed values are standard errors.

On the basis that the in vitro results showed a potential positive response to rumen digestibility, an in vivo trial was carried out. Table 4 shows the chemical composition of the hay used.

TABLE 4
Hay Composition (% by weight)

| | % DM | % CP | % NDF | % ADF | % ASH |
|---|---|---|---|---|---|
| Hay | 0.82 | 11.8 | 68.3 | 33.85 | 3.4 |

Table 5 shows the digestibility coefficients of the two rations used in the in vivo trial. The concentration of Tween 80 in the hay ration was tested against a control.

TABLE 5
Intake and digestibility coefficients from the sheep trial.

| | Control | Tween 80 |
|---|---|---|
| Intake¹ | 1.96a (0.2) | 2.06b (0.1) |
| Digestibility; | | |
| Dry matter (%) | 54.46a (0.7) | 64.70b (0.8) |
| Crude protein (%) | 52.44a (0.6) | 61.25b (0.5) |
| Acid detergent fibre (%) | 45.09a (0.5) | 52.68b (0.4) |
| Neutral detergent fibre (%) | 50.13a (0.7) | 60.63b (0.7) |

¹expressed as a % of the body weight.

Values in a row followed by different letters are significantly different (P<0.05). Bracketed values are standard errors.

From FIG. 1, is evident that either of the two surfactants increased rumen bacterial proteinase activity significantly. In comparison with Tween 60, Tween 80 would have a higher solubilizing capacity as a result of its slightly higher hydrophile-lipophile balance (HLB). The HLB for Tween 60 and Tween 80 are 14.9 and 15, respectively (Griffin et al., 1972).

It is tempting to attribute the gains in proteolysis wholly to increased enzyme access resulting from both SH unmasking and increased substrate solubility. However, higher levels of surfactants (<0.5%) would be required to achieve this. In spite of surfactant concentration, significant increases in proteolytic activity were observed at low levels (0.05-0.4%) of surfactant. The rate of SH unmasking was not significant at these points. Hence, in addition to solubility mediated SH unmasking, a different mechanism of activation must be involved, particularly at low surfactant levels. Although the mechanism of action seems unclear, it is possible that surfactant lipids would provide sites for enzyme-substrate hydrophobic interaction. Since the SH groups of most cysteine proteinases are located in hydrophobic environments within the enzymes molecules, nonionic surfactants would further enhance interaction with potential substrates.

The apparent Michaelis-Menten coefficients in Table 1 shows that for purposes of enhancing rumen proteinase function, Tween 80 would be preferred to Tween 60. Further to obtain the same activation rate (Vmax), much less Tween 80 would be needed compared to Tween 60 as is shown by a lower Km value for the former additive. Obviously, in vivo benefits would only be made if increased proteinase activity is coupled to significant increases in fibre fermentation and ultimately to enhanced nutrient digestibility.

Table 2 shows that both additives enhanced cellulose degradation rate compared to the control treatment. However, the effect due to Tween 80 was significantly greater than with Tween 60. Nonionic surfactants are widely used in industrial bioreactors, to enhance cellulose hydrolysis.

The effects of various levels of Tween 80 on the microbial enzyme source adsorption to finely ground straw are summarized in Table 3. Although 0.05-0.10% Tween 80 in the reaction mixture increased microbial enzyme source adsorption significantly (P<0.05), the effect was not additive at 0.25 or 0.50%. The adsorbing protein comprised of proteinases, cellulases, other enzymes and unlysed bacterial cells. However, the adsorption of cellulases usually parallels the rate of hydrolysis of cellulose. Hence, increased cellulase attachment at 0.5% Tween 80 may have contributed to the significantly higher rate of cellulase degradation shown in Table 7.

Table 4 shows the chemical composition of the hay fed to sheep in the trial designed to evaluate the effect of Tween 80 on intake and digestibility. A medium quality hay was used so that protein would not limit rumen function. As the results of this trial show (Table 5), Tween 80 enhanced feed intake and digestibility significantly compared to the control. There was a 5% and an 18% increase in intake and digestibility, respectively. It should be noted though that Tween 80 was included at about 0.3% in the ration. However, this was the Km concentration that is half the concentration that would elicit maximum microbial activity. Consequently, the resultant effect on digestibility would be lower than the potential.

The observed increased digestion efficiency noted above was also coupled to increased feed intake. Normally, increased feed intake is also associated with a more rapid digesta flow rate and a subsequent reduction in digestibility. That both intake and digestibility increased together, reflects the increased efficiency of the digestive enzymes, particularly in the rumen.

### EXAMPLE 3

### Carriers For Tween 80

The specific objective of this experiment was to select a carrier that will permit Tween 80 to be handled as a solid material rather than a liquid. In its natural form Tween 80 has a consistency similar to molasses and this causes concern over mixing, particularly in cold weather. Three carriers (approved for use in the feed industry) were identified and evaluated as outlined below.

The carriers were celite (Fisher Scientific Co. New Jersey, USA), diatomaceous earth (Sigma Chemical Co. St. Louis, Mo.) and LuctaCarrier (Lucta, S. A. Barcelona, Spain). Tween 80 was mixed with the carriers such that the resulting mixture contained 50% Tween 80 (wt/wt). The ability of Tween 80 in these mixtures to improve digestive efficiency was evaluated in vitro with orchardgrass hay that had been ground to pass through a 1 mm screen. Treatments included 0 (control), 0.1 and 0.2% liquid Tween 80, 0.1 and 0.2% Tween 80 in diatomaceous earth, 0.1 and 0.2% Tween 80 in celite, and 0.1 and 0.2% Tween 80 in LuctaCarrier. Appropriate quantities of each substrate were mixed with the additives and incubated in the Ankom in vitro system (Ankom Technology Fairport NY) for 22 h.

In vitro true digestibility (IVTD) of orchardgrass hay was higher (P<0.05) in all treatments containing Tween 80 except the treatment containing 0.2% Tween 80 in LuctaCarrier. The IVTD values for control, and 0.1 and 0.2% Tween 80 in liquid form, 0.1 and 0.2% Tween 80 in LuctaCarrier, 0.1 and 0.2% Tween 80 in diatomaceous earth and 0.1 and 0.2% Tween 80 in celite were: 51.44; 54.20, 54.93; 53.64, 49.45; 54.91, 55.34; 54.41, 55.63%, respectively. These results indicate that all the carriers investigated were equally effective as a means of delivering the Tween 80. The results further indicate that 0.1% (wt/wt) Tween 80 may be as effective as 0.2% Tween 80 in increasing the extent of in vitro true digestibility of orchardgrass hay.

### EXAMPLE 4

### Addition of Tween 80 to a Total Mixed Ration (TMR) Based on Silage and Barley Grain Improves Milk Production in Dairy Cows

One hundred and twenty cows and heifers in a dairy herd of Holsteins were divided into three treatment groups of 40 animals per group. All animals were given ad libitum access to a total mixed ration (TMR) based on grass silage, corn silage, grass hay, barley and canola meal. The treatments imposed were:

Treatment 1—TMR without additive (Control).

Treatment 2—TMR formulated to contain 0.2% (wt/wt) Tween 80+0.1% enzyme preparation (wt/wt).

Treatment 3—TMR formulated to contain 0.2% (wt/wt) Tween 80.

The Tween 80 was coated onto silica to form a product containing 50% Tween 80 and 50% silica. The enzyme preparation was obtained from Lucta S. A. (Barcelona, Spain). The preparation had the following activities: β-glucanase 263.0, xylanase 75.1 and amylase 542.6. Activities were expressed as nmol of reducing sugars released per mg of enzyme in 1 min at 0.83 mg/ml enzyme concentration. The trial lasted 13 weeks. Animals received their respective dietary treatments for 12 weeks. Milk production and feed intake were monitored until the 13th week (1 week after animals had been removed from dietary treatments).

Feed (TMR) offered to each group was weighed and recorded at each feeding. Each group was fed to provide a weighback of 5%. Samples of the feed offered and refused were taken daily, composited into weekly samples and dried at 55° C. for 72 hr to determine dry matter (DM) content. Daily (AM and PM) milk production by each cow was recorded. Animals were weighed two days in a row immediately after milking on a monthly basis. Milk samples were taken for compositional analyses (fat, protein, and somatic cells) in the week preceding the trial, and then during the trial at 4 week intervals. Samples were taken from both the AM and the PM milkings and analyzed individually.

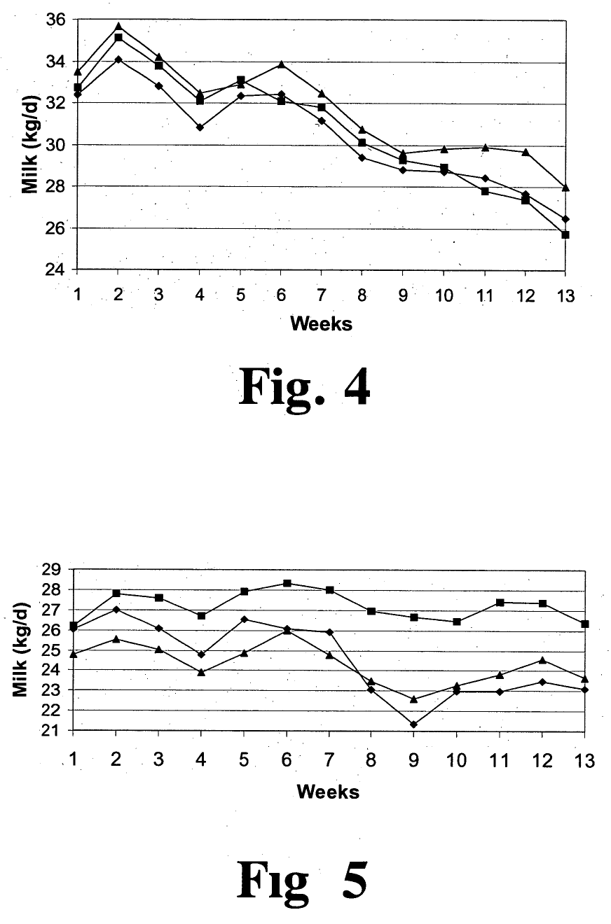

The overall milk yield for cows that were lactating at least 3 weeks prior to the start of the trial is presented in FIG. 4. Milk production from cows that received the combination of Tween 80 plus enzyme treatment was higher than the controls at all times. The upper range of the difference was close to 2 kg/cow/day. The average increase was 0.96 kg/cow/day. Over the 12-week period when cows were on their respective dietary treatments, a cow on the Tween 80 plus enzyme treatment produced 81 kg more milk than a cow on the control treatment. Compared to the control treatment, milk production was also higher in cows that received the Tween 80 alone treatment. The average improvement in milk production from Tween 80 only over the trial was 0.76 kg/cow/day. On average, a cow on Tween 80 produced a total of 64 kg more milk during the 12-week period than a cow on the control diet. The average increase in production of mature cows on Tween 80 alone was 1.31 kg/day (FIG. 4). Over the 12 weeks of the trial, a mature cow receiving Tween 80 alone produced 110 kg more milk, than a cow on the control diet, and 74 kg more than a cow receiving the treatment containing Tween 80 plus enzyme. There was a much larger response to the Tween 80 plus enzyme combination in heifers (FIG. 5). This response increased as the trial progressed. Average increase in milk production in heifers receiving the combination of Tween 80 plus enzyme was 2.6 kg/day above that of controls.

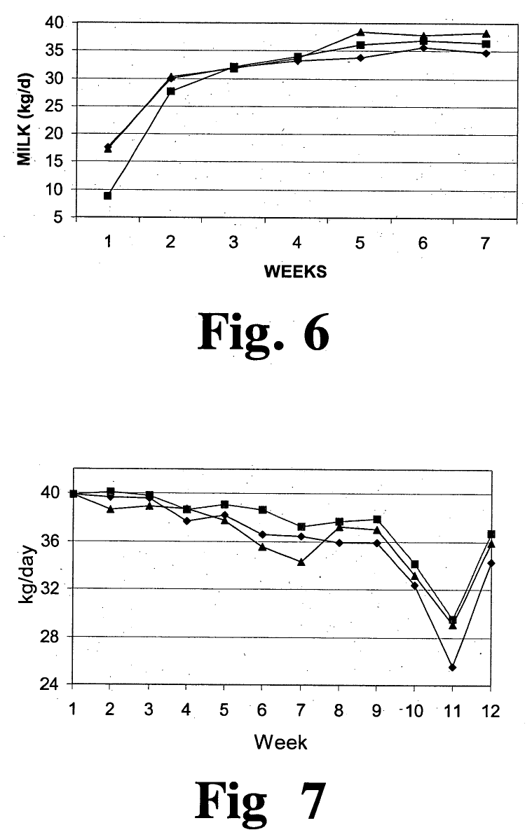

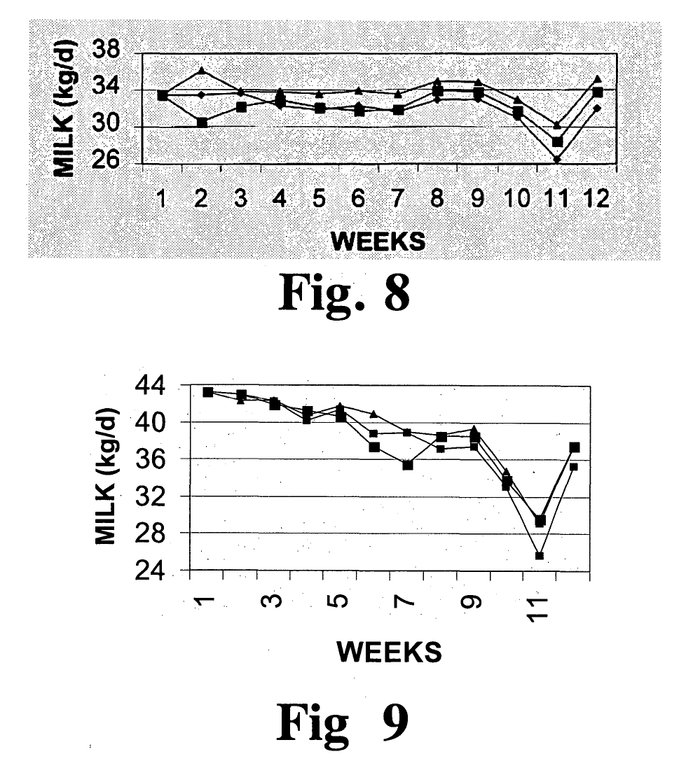

FIG. 6 shows the response of fresh cows (7 animals per treatment group) to the dietary treatments. As indicated in the figure, there was apparently no response to the dietary treatments prior to the 4th week of lactation. After the 4th week, cows on the Tween 80 only treatment produced approximately 4 kg more milk/cow/day than cows on the control treatment. The respective response by cows on the combination of Tween 80 and enzyme treatment was 2 kg more milk/cow/day. The dietary treatments did not affect milk composition (fat and protein) and somatic cell counts.

Weight Gain

Feed conversion efficiency was higher in animals that received Tween 80 in their ration. Milk produced (kg) per kg of feed consumed was 1.37, 1.40 and 1.48 for animals on the control, Tween 80 plus enzyme, and Tween 80 only treatments, respectively.

The average daily gain in weight of animals on Tween 80 plus enzyme treatment was higher than that of animals on the control treatment. Weight gain of animals on the Tween 80 alone was similar to that of animals on the control diet. This indicates that the additional milk produced by animals on Tween 80 plus enzyme, and Tween 80 only treatments was not derived from body tissue. In terms of energetic efficiency these animals were obtaining more from the diet than those on the control treatment were.

### EXAMPLE 5

### Effect of Two Levels of Tween 80 on Milk Production and Feed Intake in Cows

Seventy-five dairy cows of the Holstein breed were ranked according to lactation number, days in milk and production level and placed into three equal groups. Treatments were then randomly assigned to individual animals within the groups. There were 25 animals in each dietary treatment group. Cows were offered ad libitum access to a total mixed ration (TMR) based on grass silage, corn silage, grass hay and a commercial dairy concentrate. The treatments consisted of:

Treatment 1—Control diet (TMR).

Treatment 2—TMR containing 0.2% (w/w) Tween 80, and

Treatment 3—TMR containing 0.3% (w/w) Tween 80.

The experiment lasted 12 weeks. All cows were fed the control diet during the first week. This period served as a pretrial week. Cows in each treatment group were then fed their experimental diets for ten weeks. Milk production and feed intake were, monitored from the first week (pretrial) until the 12th week (one week after the experimental diets were withdrawn).

Ambient temperatures exceeded 40° C. during weeks 10 and 11 of the experiment resulting in considerable heat stress in the cows. Milk production and feed intake data are discussed in the light of the heat stress.

Average milk production by all animals in each treatment group is depicted in FIG. 5. Prior to the incidence of heat stress, cows on the treatment containing 0.2% Tween 80 produced about 1.1 kg/day (3%) more milk than cows on the control diet. During the first week of the heat stress (week 10), milk production by cows on the control diet fell by an average of 13.6%, while that of cows on the Tween 80 treatments fell by about 11%. The drop in milk production increased to 31.9% in cows on the control diet during week 11, compared to 23.6% in cows that received 0.2% Tween 80, and 22% in cows that received 0.3% Tween 80.

Milk production of first calf heifers in each treatment group that had calved at least 21 days prior to the start of the trial reveal that on average, animals on the dietary treatment containing 0.2% Tween 80 produced 2 kg/day more milk than animals on the control diet (FIG. 6). This number increased to more than 3.6 kg/day during the second week of heat stress, an increase of 13.6%. Mature cows (cows in second lactation or greater) on the treatment containing 0.2% Tween 80 produced 3.54 kg/day more milk on average and on the treatment containing 0.3% Tween 80 produced 3.98 kg/day more milk on average than animals on the control diet (FIG. 7).

Dry matter intake by cows on the control diet also fell by 17.4 and 30.3% during the first and second week of heat stress. The respective depressions in dry matter intake were 3.4 and 14.4% in cows on 0.2% Tween 80, and 6.0 and 12.6% in cows on 0.3% Tween 80. These results indicate the ability of Tween 80 to mitigate the effect of heat stress on feed intake and milk production.

Animals on the control treatment lost about 3.5 kg in weight during the first 30 d of the experiment and 1 kg during the last 60 d of the experiment. Cows on 0.2% Tween 80, however, gained 1 kg during the first 30 d and 9 kg during the last 60 days of the experiment. The respective weight gains in cows on 0.3% Tween 80 were 2.5 and 4.5 kg. This is an indication that the extra milk produced by these animals was not derived from mobilization of body reserves.

### EXAMPLE 6

### Effect of Tween 80 on Performance of Feedlot Cattle

Three hundred and twenty six Red Angus steers were stratified by weight and divided into eight pens. The pens were then randomly assigned to one of the following four dietary treatments:

1) control

2) 0.1% (wt/wt)Tween 80

3) 0.2% (wt/wt) glycanase enzyme (enzyme)

4) 0.01% Tween 80+0.2% enzyme.

The enzyme is marketed by GNC Bioferm Inc., Saskatoon, SK. The product contained the following activities (expressed as nmol of reducing sugars released from 1 mg of product per min: xylanase (336.6), β-glucanase (196.0), carboxymethylcellulase (44.4), and amylase (46.3). The basal diet was a total mixed ration consisting of rolled barley, corn silage and canola meal. Tween 80 was diluted with tap water (1 in 5) before it was applied. The total amount of feed required each day for the animals on each treatment was weighed separately in a mixer wagon and the appropriate quantity of Tween 80, enzyme, or their combination applied to it and mixed for ten minutes before feeding. An equal volume of water as applied to the Tween 80 treatment was also applied to the control and enzyme treatment to make the moisture content of the four experimental diets equal. The experimental diets were fed for a total of 119 days. Individual body weights were taken at the beginning and end of the experiment. Group body weights were taken at monthly intervals.

Overall body weight changes and feed efficiency in animals on each of the dietary treatments are indicated in Table 3.1 below. At the end of the 119 days, animals that consumed diets containing 0.1% Tween 80 had gained approximately 5.8% more weight than animals on the control diet. Average daily gain in these animals was 6.3% higher than in animals consuming the control diet. Feed efficiency was also better in animals on the 0.1% Tween 80 treatment.

TABLE 6
Average daily gain and feed efficiency
in steers fed Tween 80 and enzyme for 119 days¹

| | | | Average | Feed |
|---|---|---|---|---|
| | Initial Body | Total Weight | Daily Gain | Efficiency |
| Treatment2 | Weight (kg) | Gain (kg) | (kg/d) | (Gain/Feed) |
| Control | 422.98 | 207.03b | 1.59b | 0.160 |
| 0.1% Tween 80 | 427.97 | 219.03a | 1.69a | 0.166 |
| 0.2% Enzyme | 430.24 | 211.66b | 1.63ab | 0.163 |
| 0.01% Tween | 425.47 | 207.53b | 1.60b | 0.160 |
| 80 + 0.2% | | | | |
| Enzyme | | | | |

¹Means in the same column with different superscripts differ (P < 0.05)
²Concentrations are on dry matter basis.

### EXAMPLE 7

### Accelerated Oxidation Tests

Solid silica particles (LuctaCarrier™ silica, Lucta, S. A., Barcelona, Spain) are coated 50% wt/wt (based of the combined weight of the particles and coating) with a mixture of polyethylene 20 sorbitan monooleate (Polysorbate 80) and an amount of the antioxidants set forth in the tables, below, or no antioxidant as a control. The liquid antioxidants (e.g., ethoxyquin) are mixed directly with the Polysorbate 80 at the concentrations set forth in the tables. The solid antioxidants (e.g., BHA or BHT) are dissolved in a suitable solvent (e.g., ethyl alcohol) and then mixed with the Polysorbate 80 at the listed concentration levels. The oxidative stability of the coating is then determined using the Rancimat test. Oxidative stability relates to how easily components of oil oxidize which creates off-flavors in the oil, and is measured by instrumental analysis using accelerated oxidation methods. American Oil Chemists' Society Official Method Cd 12-57 for Fat Stability: Active Oxygen Method (re'vd 1989); Rancimat (Laubli, M. W. and Bruttel, P. A., JOACS 63:792-795 (1986)); Joyner, N. T. and J. E. McIntyre, Oil and Soap (1938) 15:184 (modification of the Schaal oven test). The Rancimat method has been developed as the automated version of the AOM method (active oxygen method) for the determination of the induction time of fats and oils. In this method the highly volatile organic acids produced by autoxidation are absorbed in water and used to indicate the induction time. As used in the following tables, the abbreviations have the following meanings:

BHT=butylated hydroxytoluene

BHA=butylated hydroxyanisole

EQ=ethoxyquin

TABLE 7

| | Concentration | Rancimat |
|---|---|---|
| Antioxidant | (ppm) | Stability (hours) |
| Control | None | 1.5 |
| BHT | 200 | 1.75 |
| BHT + BHA | 100 + 100 | 3.85 |
| BHT + tocopherols | 200 + 200 | 3.90 |

TABLE 8

| | Concentration | Rancimat |
|---|---|---|
| Antioxidant | (ppm) | Stability (hours) |
| Control | None | 1.5 |
| BHT | 200 | 1.85 |
| BHT + BHA | 100 + 100 | 3.85 |
| BHT + tocopherols | 200 + 200 | 6.05 |

TABLE 9

| | Concentration | Rancimat |
|---|---|---|
| Antioxidant | (ppm) | Stability (hours) |
| Control | None | 2.5 |
| BHT | 200 | 4.45 |
| BHT + BHA | 100 + 100 | 14.20 |
| BHT + tocopherols | 200 + 200 | 24.15 |

TABLE 10

| | Concentration | Rancimat |
|---|---|---|
| Antioxidant | (ppm) | Stability (hours) |
| Control | None | 2.5 |
| BHT | 200 | 6.15 |
| BHT + BHA | 100 + 100 | 17.35 |
| BHT + tocopherols | 200 + 200 | 15.75 |
| EQ | 200 | 42.70 |
| EQ | 500 | 60.60 |
| EQ | 1000 | 87.50 |

TABLE 11

| | Concentration | Rancimat |
|---|---|---|
| Antioxidant | (ppm) | Stability (hours) |
| Control | None | 1.70 |
| EQ | 1000 | 79.40 |

TABLE 12

| | Concentration | Rancimat |
|---|---|---|
| Antioxidant | (ppm) | Stability (hours) |
| Control | None | 1.70 |
| EQ | 1000 | 97.20 |

### EXAMPLE 8

### Accelerated Oxidation/Shelf Life Test

The nonionic surfactant polyoxyethylene 20 sorbitan monooleate (Polysorbate 80) is coated in an amount of 50% wt/wt onto silica particles (i.e., in the proportion 50 g. of Polysorbate 80 per 50 g. of silica), either without (control) or with added antioxidant. A shelf life test is performed by measuring, using a sensory panel, the level of rancid odor of samples stored at 40° C., with a rancidity score being assigned to each sample (with a score of 0 for no rancid odors and 10 for highest level of rancid odors. The results are shown in Table 13, below.

TABLE 13

| | Concentration | Rancidity Score | | | |
|---|---|---|---|---|---|
| Antioxidant | (ppm) | 1 week | 2 weeks | 6 weeks | 10 weeks |
| Control | | 3.0 | 6.0 | 9.0 | 10.0 |
| EQ | 1000 | 1.0 | 2.0 | 3.5 | 5.0 |
| BHT + EQ | 200 + 200 | 2.0 | 3.5 | 5.0 | 7.5 |

### EXAMPLE 9

### Field Trial

Ruminating animals have a capability for the digestion of dietary fibre components, because of microbial fermentation in the rumen. However, feed conversion ratio can be improved if the diet is supplemented with one or more nutritionally active ingredients such as enzymes, buffers, essential oils, vitamins and amino acids. The improvement of the diet digestibility is associated with increase of feed intake, which is especially significant during the first stage of lactation. In accordance with the present invention, antioxidant stabilized surfactant feed additives are used increase milk yield and also cause an improvement of the body condition, as less nutrients would have to be mobilized from the cow's own tissues.

To field test the present invention, a feed additive, described herein as Feed Additive A, was developed based on a combination of nutritionally active compounds for dairy cows, composed of a vitamin supplement, essential oils, palatability enhancers, a non-ionic surface-active agent and an antioxidant. The specific formulation of Feed Additive A is as follows:

Feed Additive A Composition

| Component | % by Weight |
|---|---|
| Polysorbate 80 | 53.3 |
| Silicon dioxide (E551b) | 42.84 |
| Niacin | 3.0 |
| Flavoring substances* | 0.8 |
| Ethoxyquin | 0.06 |

*rosemary oil (alfa-pinene), eucalyptus oil (cineole), clove essential oil (eugenol), p-anisaldehyde, gamma-undecalactone, benzyl alcohol, cinnamaldehyde, benzaldehyde

Niacin was included in the formulation since niacin supplementation to high production dairy cows improves their metabolic efficiency by reducing fat and body protein mobilisation and increasing glucose plasma levels. This causes a higher milk yield (Jaster, E. A. et al., “Feeding supplemental niacin for milk production in six dairy herds” J. Dairy Sci., 63:1737 (1983)), increase of milk fat (Fronk, T. J. et al., “Effect of dry period overconditioning on subsequent metabolic disorders and performance of dairy cows” J. Dairy Sci. 62:1804 (1980)) and protein (Cervantes, A. et al., “Effects of nicotinamide on milk composition and production in dairy cows fed supplemental fat” J. Dairy Sci. 79:105 (1996)), especially during the hot season (Muller, L. D. et al., “Supplemental niacin for lactating cows during summer feeding” J. Dairy Sci., 69:1416 (1986)). The effects of the niacin supplementation might be more significant during the lactation's first stage of heifers, and under heat stress conditions (NRC. Nutrient requirements of dairy cattle. 6th revised edition. National Academy Press. Washington, D.C., pp. 47 (1989)).

A field trial of the formulation was carried out on “Las Traviesas” farm (Saprogal, Spain) for a full lactation period. In the field trial, a total of 100 cows were classified into two groups according to their parturition number:

1. first parturition (G₁ or Heifer)

2. more than one parturition (G₂ or Mature)

When the calving period started, each animal was assigned to any of two treatments:

T₁ or Control: Without Feed Additive A

T₂ or Feed Additive A: With 80 g/cow/day of Feed Additive A

The number of individuals in either group (Heifer vs. Mature) assigned to either treatment (Table 8) shows a slight imbalance, as the Feed Additive A treatment included 60% heifers while the control treatment included 52% heifers. The number of records by lactation is similar for both groups, allowing for good predictions until 305 days. When the controls were ended, 40% of all cows were more than 300 days in lactation, there were records for at least one full lactation and more than 65% of all animals were more than 250 days into lactation. The data from cows not having at least 3 complete records at the end of the experimental period (milk production and milk analysis) were not considered for the statistical analysis.

TABLE 14
Animal distribution and records analyzed by group and
treatment (includes the milk control on 19/11/00)

| | Control | | | Feed Additive A | | |
|---|---|---|---|---|---|---|
| | Heifer | Mature | Total | Heifer | Mature | Total |
| No. of animals | 27 | 25 | 52 | 29 | 19 | 48 |
| No. records | 222 | 180 | 402 | 231 | 136 | 367 |
| Records/cow, ave. | 8.2 | 7.2 | 7.7 | 8.0 | 7.2 | 7.6 |

Feed Additive A was supplied as follows. A feed was prepared into which 840 kg of wheat were mixed with 160 kg of Feed Additive A, and the mixture was pelleted. 500 g of the pelleted mixture was daily delivered to T₂ animals, thereby supplying 80 g Feed Additive A plus 420 g of wheat. The cows from group T₁ (no Feed Additive A) received 420 gram of wheat daily to balance the amount of this cereal contained in treatment T₂ (Feed Additive A).

The animals were cared for following the routine practices in the farm, including two milking periods each day, in the morning and in the afternoon.

The feeding management included a base ration for lactation that covered up to 25 kg milk daily that was delivered to all cows twice a day. Its ingredient and nutrient composition are included in Tables 15A and 9B.

TABLE 15A
Base Ration Ingredient Composition

| Ingredient | kg/cow/day, dry matter |
|---|---|
| Gluten feed | 15.0 |
| Wheat | 21.6 |
| Lupines | 6.2 |
| Maize | 10.0 |
| D.D.G. | 5.0 |
| Soya bean meal 44% | 23.0 |
| Palm meal | 10.0 |
| Fish meal, 65% | 2.0 |
| Dairy premix | 7.2 |
| Cost, US$/t | 151 |

Base Ration Nutrient Composition

| Production feed | |
|---|---|
| nutritional analysis | Amount |
| Dry matter, % | 89.06 |
| Crude protein, % | 22.00 |
| PDIE, % | 130.0 |
| PDIN, % | 151.1 |
| PDIA | 77.7 |
| Ash, % | 7.33 |
| Starch, % | 23.00 |
| A.D.F., % | 9.86 |
| N.D.F., % | 20.82 |
| Crude fat, % | 6.02 |
| U.F.L./kg | 105.1 |

This base ration was supplemented with the production feed. (whose composition is included into Tables 15C and 15D), at a ratio of 1 kg feed per 2.5 kg of extra milk produced above the 25 kg base level.

Production Feed Ingredient Composition

| Ingredient | kg/cow/day, dry matter |
|---|---|
| Gluten feed | 15.0 |
| Wheat | 21.6 |
| Lupines | 6.2 |
| Maize | 10.0 |
| D.D.G. | 5.0 |
| Soya bean meal 44% | 23.0 |
| Palm meal | 10.0 |
| Fish meal, 65% | 2.0 |
| Dairy premix | 7.2 |
| Cost, US$/t | 151 |

TABLE 15D
Production Feed Nutrient Composition

| Base ration nutritional analysis | Amount |
|---|---|
| Dry matter, % | 89.06 |
| Crude protein, % | 22.00 |
| PDIE, % | 130.0 |
| PDIN, % | 151.1 |
| PDIA | 77.7 |
| Ash, % | 7.33 |
| Starch, % | 23.00 |
| A.D.F., % | 9.86 |
| N.D.F., % | 20.82 |
| Crude fat, % | 6.02 |
| U.F.L./kg | 105.1 |

Feed Additive A was supplied as a wheat-based, pelleted feed and dosed at 500 g of pellet/cow/day. The Feed Additive A-containing feed pellets substituted an equivalent amount of production feed. The cows with a milk yield lower than 25 kg/day and that therefore did not receive production feed, were only given a base ration supplemented with the Feed Additive A/wheat mixture. The nutritional composition of the Feed Additive A/wheat mixture is set forth in Table 16.

TABLE 16
Wheat/Feed Additive A Mix Nutritional Analysis

| Nutritional Analysis | Amount |
|---|---|
| Dry matter, % | 67.90 |
| Crude protein, % | 8.40 |
| PDIE, % | 7.30 |
| PDIN, % | 5.50 |
| Nitrogen Free Extract, % | 52.30 |
| Starch, % | 45.90 |
| Crude fibre, % | 1.80 |
| A.D.F., % | 2.60 |
| N.D.F., % | 9.80 |
| Calcium, % | 0.03 |
| Total P, % | 0.28 |
| Crude fat, % | 3.60 |
| Metabolisable energy, kcal/kg | 2381 |
| Net energy lactation, kcal/kg | 1427 |
| U.F.L./kg | 0.87 |

The following parameters were recorded and analyzed:

Milk production: the amount of milk yield per cow/day, using the monthly yield control from the farm.

Milk quality: protein and fat analysis and somatic cell count on a monthly basic.

Body weight: assessment of body weight changes every two months from the beginning to the end of the lactation period, using chest perimeter measurement with weigh tape.

Interval calving/fecundation (fertility index): the time between calving and first, fertile service was determined. Those cows that were not pregnant at the end of the experiment were removed from the statistical analysis.

Cow Judging: including limb assessment, udder and final morphological rating.

Statistical Analysis

For the statistical analysis of daily milk yield (MY, kg/day) the SAS MIXED procedure (Littell, R. C. et al., SAS System for Mixed Models, Cary, N.C., SAS Institute Inc. 1996) was used for the development of a fourth degree polynomial model, depending on the lactation day, and with random regression coefficients. The model uses as fixed effects Treatment (Control vs. Feed Additive A) and Group (Heifer vs. Mature).

Fat, protein and the evolution of somatic cells count were adjusted to a third degree polynomial equation. The somatic cell count was transformed into “Linear Score” that takes the logarithm function of counts into consideration according to the following formula:

$$Linear Score = \frac{Log ( Cell count \times {10}^{3}}{Log 2}$$

The use of random coefficients on the models allow the regression coefficients to vary from animal to animal, each coefficient being constituted by a fixed segment, and a random segment that changes according to a distribution estimated by the model itself. Additionally, this model accounts for the repeated measurements on a single animal and allows comparing the differences existing in any given point between two curves. A third feature is the possibility of coefficient comparison from the equations but such option was discarded, as these coefficients do not have any biological significance.

Results and Discussion

Analysis of Morphological Score

Each animal was scored for feet and leg, udder composite and final global scoring, with the aim of detecting possible differences at the origin or random differences between groups and treatments. Even if this value has lower accuracy than the ICO genetic value that includes a weighed calculation of productive parameters (10% kg of fat+51% kg of protein+5% percent of protein) and score values (4% for limbs+15% for the udder +15% final morphological score), the morphological score alone is considered to be a correlated indicator for genetic potential. This value tends to underscore the animals on its first parturition; therefore it is normal to observe lower values for heifers than for mature animals in this experiment. However, no significant differences among treatments were detected in the experiment (76.2 vs. 76.7; Table 11), so it is assumed that the genetic potential of both groups was balanced at the origin and does not interfere with Feed Additive A assessment.

TABLE 17
Morphological Score

| | |
|---|---|
| Control | Feed Additive A |

| | Heifer | Mature | Heifer | Mature |
|---|---|---|---|---|
| Genetic value | 75.1 | 77.1 | 75.5 | 78.1 |

| | | |
|---|---|---|
| Average | 76.2 | 76.7 |

### Analysis of Daily and Cumulative Productions

The control cows of the farm were of high yield with a production peak close to 40 kg/cow/day for heifers plus mature animals (Table 18), and a cumulative production of 9429 kg/cow in 305 days (Table 12). These data equal to an average production of 31 kg of milk per cow/day.

TABLE 18
Comparison of milk production in kg/day
on successive lactation days, by treatment

| | | Feed | | | |
|---|---|---|---|---|---|
| Day | Control | Additive A | Difference, kg | Difference, % | t |
| 10 | 28.8 | 29.2 | 0.28 | 1.1 | 0.553 |
| 30 | 34.6 | 35.5 | 0.81 | 2.6 | 0.457 |
| 60 | 38.9 | 40.5 | 1.59 | 4.1 | 0.298 |
| 90 | 39.3 | 41.4 | 2.31 | 5.4 | 0.157 |
| 100 | 38.9 | 41.1 | 2.53 | 5.8 | 0.122 |
| 120 | 37.4 | 39.9 | 2.96 | 6.8 | 0.071 |
| 150 | 30.6 | 33.8 | 3.52 | 10.2 | 0.032 |
| 180 | 28.3 | 31.6 | 3.98 | 11.5 | 0.016 |
| 200 | 27.2 | 30.5 | 4.21 | 12.1 | 0.011 |
| 210 | 24.2 | 27.6 | 4.30 | 14.1 | 0.010 |
| 240 | 23.3 | 26.7 | 4.46 | 14.7 | 0.014 |
| 270 | 21.5 | 25.0 | 4.42 | 15.9 | 0.032 |
| 300 | 18.9 | 22.2 | 4.15 | 18.5 | 0.096 |
| 305 | 18.4 | 21.7 | 4.08 | 17.8 | 0.115 |

Feed Additive A supplementation resulted into important yield increases from the 30th lactation day onwards (0.81 kg/cow/day, equalling to an average increase of 2.6%). The results started to be statistically significant from the fourth lactation month onwards, with increases of up to 3 kg/cow/day, (6.8%; Table 18). From day 300 onwards, yield increases (17.8%; Table 12), but they are no longer statistically significant because of an increased variability and the decrease on the number of animals reaching this late stage of the lactation curve.

TABLE 19
Comparison of milk production in kg/day
on successive lactation days, by group and treatment

| | Heifer | | | | Mature | | | |
|---|---|---|---|---|---|---|---|---|
| | | Feed | Diff. | | | Feed | Diff. | |
| Day | Control | Additive A | kg/d | Diff. % | Control | Additive A | kg/d | Diff. % |
| 10 | 23.4 | 24.1 | 0.7 | 3.2 | 34.3 | 34.2 | −0.1 | −0.3 |
| 30 | 29.2 | 31.1 | 2.0 | 6.7 | 40.1 | 39.9 | −0.2 | −0.4 |
| 60 | 33.8 | 37.0 | 3.2 | 9.4 | 43.9 | 43.9 | 0.0 | 0.0 |
| 90 | 35.1 | 38.9 | 3.9 | 11.1 | 43.6 | 44.0 | 0.4 | 0.8 |
| 100 | 34.9 | 39.0 | 4.0 | 11.5 | 42.8 | 43.3 | 0.5 | 1.2 |
| 120 | 34.2 | 38.4 | 4.2 | 12.4 | 40.6 | 41.4 | 0.8 | 2.1 |
| 150 | 30.1 | 34.6 | 4.5 | 15.0 | 31.2 | 32.9 | 1.7 | 5.5 |
| 180 | 28.7 | 33.3 | 4.6 | 15.9 | 27.9 | 29.8 | 1.9 | 6.9 |
| 200 | 28.1 | 32.7 | 4.6 | 16.4 | 26.3 | 28.3 | 2.0 | 7.6 |
| 210 | 26.5 | 31.2 | 4.7 | 17.9 | 21.9 | 24.0 | 2.1 | 9.6 |
| 240 | 26.0 | 30.7 | 4.8 | 18.4 | 20.6 | 22.7 | 2.1 | 10.1 |
| 270 | 25.0 | 29.9 | 4.9 | 19.4 | 18.0 | 20.0 | 2.0 | 11.0 |
| 300 | 23.4 | 28.4 | 5.0 | 21.2 | 14.4 | 16.1 | 1.7 | 11.5 |
| 305 | 23.1 | 28.1 | 5.0 | 21.6 | 13.8 | 15.4 | 1.6 | 11.5 |

Analyzing by group the results of Feed Additive A addition, it is clear that first parturition cows show better response than cows (21.6% vs. 11.5%; Table 19). The analysis of cumulative milk production shows the same trend than the daily production: the effect of Feed Additive A supplementation is highly significant from the first month of lactation. The cumulative milk production at 305 days improves by 8.1%, or 767 kg of milk per cow. It is evident the higher level of response from the animals on the Heifer group than the animals from the Mature group, 13.3% versus 3.4%, respectively (see Table 21).

TABLE 20
Cumulative milk production in kg and percent differences
in successive lactation days, according to treatment

| Day | Control | Feed Additive A | Diff., kg/cow | Diff., % | t |
|---|---|---|---|---|---|
| 10 | 269 | 271 | 1.6 | 0.6% | 0.142 |
| 30 | 908 | 922 | 14.0 | 1.5% | 0.119 |
| 60 | 2022 | 2074 | 51.7 | 2.6% | 0.086 |
| 90 | 3203 | 3311 | 107.7 | 3.4% | 0.057 |
| 100 | 3594 | 3724 | 129.6 | 3.6% | 0.049 |
| 120 | 4358 | 4536 | 177.8 | 4.1% | 0.036 |
| 150 | 6407 | 6756 | 340.1 | 5.4% | 0.021 |
| 180 | 6996 | 7409 | 412.8 | 5.9% | 0.012 |
| 200 | 7274 | 7719 | 445.6 | 6.7% | 0.008 |
| 210 | 8044 | 8590 | 546.5 | 6.8% | 0.007 |
| 240 | 8281 | 8862 | 580.7 | 7.0% | 0.004 |
| 270 | 8729 | 9378 | 649.3 | 7.4% | 0.003 |
| 300 | 9336 | 10087 | 750.8 | 8.0% | 0.002 |
| 305 | 9429 | 10197 | 767.3 | 8.1% | 0.002 |

TABLE 21
Cumulative milk production in kg/cow and
differences existing among treatments (kg/cow and %) by group

| | Heifer | | | | Mature | | | |
|---|---|---|---|---|---|---|---|---|
| | | Feed | Diff., | | | Feed | Diff., | |
| Day | Control | Additive A | kg/cow | Diff., % | Control | Additive A | kg/cow | Diff., % |
| 10 | 215 | 218 | 3.8 | 1.8% | 324 | 323 | −0.5 | −0.2% |
| 30 | 744 | 776 | 31.5 | 4.2% | 1073 | 1069 | −3.4 | −0.3% |
| 60 | 1700 | 1809 | 109.9 | 6.5% | 2345 | 2339 | −6.5 | −0.3% |
| 90 | 2739 | 2956 | 216.7 | 7.9% | 3666 | 3665 | −1.4 | 0.0% |
| 100 | 3090 | 3346 | 256.2 | 8.3% | 4099 | 4102 | 3.0 | 0.1% |
| 120 | 3782 | 4121 | 339.1 | 9.0% | 4934 | 4950 | 16.5 | 0.3% |
| 150 | 5717 | 6321 | 603.7 | 10.6% | 7097 | 7191 | 94.4 | 1.3% |
| 180 | 6305 | 7000 | 694.7 | 11.0% | 7687 | 7818 | 130.9 | 1.7% |
| 200 | 6589 | 7330 | 740.7 | 11.2% | 7958 | 8109 | 150.5 | 1.9% |
| 210 | 7407 | 8288 | 880.7 | 11.9% | 8680 | 8893 | 212.3 | 2.4% |
| 240 | 7669 | 8598 | 928.1 | 12.1% | 8893 | 9126 | 233.3 | 2.6% |
| 270 | 8179 | 9204 | 1024.4 | 12.5% | 9278 | 9552 | 274.2 | 3.0% |
| 300 | 8907 | 10079 | 1172.0 | 13.2% | 9765 | 10094 | 329.5 | 3.4% |
| 305 | 9024 | 10220 | 1196.9 | 13.3% | 9835 | 10173 | 337.5 | 3.4% |

***FIG. 3 presents a curve of estimation of differences between control and Feed Additive A as cumulative milk, in kg, per cow and lactation. The third degree equation is a good predictive tool that follows the lactation day, as its R squared shows very high value. y = −0.0184x3 + 1.3849x2 − 1.1995x − 1.241 R² = 0.9999

### Analysis of Values and Curves for Fat, Protein and Somatic Cell Count

As shown in Table 22, the percent of milk protein is not influenced by group effect (Heifer vs. Mature). However, the fat percent is influenced, as the Heifer group shows significantly higher fat values than the Mature group. Treatment comparisons (control vs. Feed Additive A) do not show differences in protein or fat composition. Standardisation of milk production by fat values (3.7% or 4% fat as reference value) does not provide any improvement to the statistical analysis, due probably to the high variability of milk fat values obtained from individual cows (data not shown). Additionally, fat and protein standardisation is usually performed on cumulative production from 305-day lactations, on average protein or fat values, and not on daily milk values.

TABLE 22
Average of squared minimum for protein,
fat and Somatic Cell Count values, by group and treatment

| | | | | Treatment | | |
|---|---|---|---|---|---|---|
| | Group | | | | Feed | |
| | Heifer | Mature | Diff.¹ | Control | Additive A | Diff.¹ |
| Protein, % | 3.23 ± 0.184 | 3.32 ± 0.293 | ns | 3.30 ± 0.253 | 3.24 ± 0.223 | ns |
| Fat, % | 4.5 ± 0.283 | 4.18 ± 0.296 | *** | 4.38 ± 0.276 | 4.30 ± 0.279 | ns |
| Linear Score, (Somatic | 3.18 ± 0.363 | 4.64 ± 0.446 | *** | 3.58 ± 0.436 | 4.24 ± 0.376 | * |
| Cells)² | | | | | | |

¹ns; not significant; *: p < 0.05; **; p < 0.01; ***: p < 0.001
²Computed following a log function from Somatic Cell Count, after Lundeen, T., “Mastitis management: monitoring SCC reduces mastitis incidence,” Feedstuffs, 9: Jan. 8, 2001.

The average protein values do not show significant differences. However, in Mature cows the analysis of the values curve resulted in significant differences from day 170 to day 250 into the lactation. This indicates that, for that period, the Mature Feed Additive A-fed cows produce milk with a protein content 0.1% lower than the control group (Table 23). This decrease was not identified in either Heifers or in the total animal assay pool, as indicated in the previous comments for Table 16. The curve far protein content in milk shows a steady decrease, parallel to the increase of milk production common to the two groups and treatments. The cumulative net protein production is higher in Feed Additive A-fed cows, because of the significant increase of milk yield from those animals.

TABLE 23
Comparison of milk protein content,
by group and treatment

| | Heifer | | | | Mature | | | |
|---|---|---|---|---|---|---|---|---|
| | | Feed | | | | Feed | | |
| | | Addi- | | | | Addi- | | |
| Day | Control | tive A | Diff. | t | Control | tive A | Diff. | t |
| 10 | 3.8 | 3.07 | 0.00 | 0.794 | 3.14 | 3.15 | −0.01 | 0.194 |
| 30 | 3.05 | 3.04 | 0.01 | 0.719 | 3.06 | 3.09 | −0.03 | 0.294 |
| 60 | 3.05 | 3.03 | 0.02 | 0.598 | 3.01 | 3.03 | −0.02 | 0.586 |
| 90 | 3.07 | 3.04 | 0.03 | 0.485 | 3.03 | 3.03 | 0.01 | 0.898 |
| 100 | 3.08 | 3.04 | 0.04 | 0.454 | 3.05 | 3.03 | 0.02 | 0.706 |
| 120 | 3.11 | 3.07 | 0.04 | 0.407 | 3.10 | 3.06 | 0.05 | 0.384 |
| 150 | 3.18 | 3.12 | 0.05 | 0.380 | 3.22 | 3.12 | 0.09 | 0.139 |
| 180 | 3.25 | 3.19 | 0.06 | 0.406 | 3.36 | 3.22 | 0.14 | 0.068 |
| 200 | 3.31 | 3.19 | 0.06 | 0.450 | 3.46 | 3.30 | 0.16 | 0.057 |
| 210 | 3.33 | 3.28 | 0.06 | 0.480 | 3.51 | 3.34 | 0.17 | 0.056 |
| 240 | 3.42 | 3.37 | 0.05 | 0.602 | 3.67 | 3.49 | 0.18 | 0.077 |
| 270 | 3.50 | 3.47 | 0.03 | 0.778 | 3.81 | 3.65 | 0.17 | 0.157 |
| 300 | 3.57 | 3.57 | 0.00 | 0.992 | 3.94 | 3.82 | 0.12 | 0.400 |
| 305 | 3.58 | 3.58 | −0.01 | 0.951 | 3.95 | 3.85 | 0.10 | 0.466 |

As far as milk fat is concerned, there were no significant differences between treatments in either Heifers or Mature cows or in both groups taken together. However, the differences from Mature cows indicate a certain trend towards a slight decrease in fat content associated to Feed Additive A treatment. As with protein, the cumulative total fat production was higher in the Feed Additive A-fed cows due to the significantly higher milk yield of these animals. Due to the differences in the individual variations there were no significant differences between treatment and group, although differences between groups existed when analyzing absolute averages.

TABLE 24
Main equivalence of the Lineal Index (“Linear
Score” LS) for Somatic Cell Count (SCC).

| | Linear Score | | | | | | | | | |
|---|---|---|---|---|---|---|---|---|---|---|
| | 0 | 1 | 2 | 3 | 4 | 5 | 6 | 7 | 8 | 9 |
| S.C.C., × 10³ | 12.5 | 25 | 50 | 100 | 200 | 400 | 800 | 1600 | 3200 | 6400 |

Adapted from Lundeen, 2001, supra

As far as the Somatic Cell Count (SCC) is concerned, the statistical analysis was carried out on a linear index (“linear score”—LS). This value is computed from the logarithm function of the actual value of cell count (see Section 3). The correlation between LS and SCC are set into Table 24, adapted from the work of Lundeen (2001). LS differences were significant between both Heifers and Mature (P<0.01) and between treatments (P<0.05), and associated to a higher index in the Feed Additive A treatment. At day 305, the average difference is 0.66 lineal points (see Table 22). The SCC was not included as parameter for the initial cow classification which caused the animals in the Feed Additive A group to have higher initial counts, which were carried over the entire lactation. The general farm records confirmed that the Mature cows (more than one parturition) show LS-SCC levels higher than 4.0, irrespective of treatment. These levels can be considered quasi pathological. Levels higher than 6.0 lineal points are indicative of clinical mastitis, that were identified in 8 animals fed Feed Additive A and in four central animals. On the other hand, the difference of SCC causes a decrease on the economic performance of the Feed Additive A treatment. As reported by the American National Mastitis Council, every point of increase in the LS reduces the total lactation milk yield by 100 kg in first parturition cows and by 200 kg in cows with more than one parturition. These values average 0.35 y 0.70 kg/cow/day respectively.

### Body Condition and Calving-To-Pregnancy Interval

As estimation of body condition, each animal had its barrel perimeter recorded at the beginning of the experiment and every two/three month thereafter. This way there were some four measurements from each animal at the end of the lactation period. Data analysis shows, however, that the method is not sufficiently accurate and that there is very wide variability even at individual level.

As for fertility, the time lag between calving and the first fertile service was used as indicator. At the end of the trial and using the fertility data to January 2001, the farm's average was 140 days, a bit over the optimal and that set the calving-to-calving interval clearly over 400 days. This might be because of IBR infection interference, a fact suggested by the farm's veterinary services. The study shows that more control cows were open at the end of the trial with more than 150 days (19.2% of control cows and 12.5% of Feed Additive A-cows).

There were no important differences between groups on the calving-to-pregnancy interval (3.0 days less for Heifers) but the differences between treatments Were significant, with a pooled average of 24.7 days less for Feed Additive A-fed animals (P=0.1093, Table 17). First parturition animals Feed Additive A-fed responded reducing the calving-to-pregnancy interval by 33.8 days, while the response of more mature animals was somewhat lower, reducing this interval by 9.7 days.

TABLE 25
Compared results from calving-to-pregnancy
interval in days, by group and treatment,
and percentage of open cows by treatment

| | Open¹, | | | | | |
|---|---|---|---|---|---|---|
| | >150 | Heifer, | Mature, | Average | | |
| | days | days | days | treatment | S.D. | P treatment² |
| Control, | 19.2% | 142.0 | 133.2 | 138.5 | 69.3 | 0.109 |
| days | | | | | | |
| Feed | 12.5% | 108.2 | 123.5 | 113.8 | 55.8 | |
| Additive | | | | | | |
| A, days | | | | | | |
| Difference | 6.7% | 33.8 | 9.7 | 24.7 | | |
| control | | | | | | |
| Feed | | | | | | |
| Additive | | | | | | |
| A | | | | | | |
| Average, | | 125.9 | 128.9 | | | |
| groups | | | | | | |
| P. groups | | 0.888 | | | | |

¹Percentage of cows open at the end of the trial with more than 150 days from calving.
²The difference between treatment means was statistically significant (P = 0.1093)

General Discussion

The overall assessment of the farm used for the field trial showed a unit with an average milk yield of 31 kg/cow/day with 4.38% fat and 3.30 protein, for a 305-day lactation. SCC values were rather high and especially so in cows with more than one parturition, which had an average linear value of 4.0, bordering the clinical stage. Mastitis with linear values higher than 6.0 was identified on some individuals. The calving-to-pregnancy interval was about 140 days, longer then desirable and the calving to calving interval was found at around 400 days. The veterinary services also diagnosed some cases of IBR (Infectious Bovine Rhynotracheitis).

The supplementation of the diet with Feed Additive A resulted into a highly significant increase in milk yield and a decrease of the calving-to-pregnancy interval. (Table 26). The observed differences in fat and protein content were not significant, but must be included when evaluating the economy of the experiment. The cumulative production of milk fat and protein was favoured by the Feed Additive A treatment. Finally, the SCC analysis shows that Feed Additive A did not influence this parameter, when taking into account the significantly higher (0.7 LS-SCC points, Section 4.3) initial values from the Feed Additive A-treated animals.

TABLE 26
Summary of compared results for the main parameters
in control and treated groups

| | | | | | | | | | Calving- | |
|---|---|---|---|---|---|---|---|---|---|---|
| | | | | | | | | | pregnancy | |
| | Milk, | | | | | | | | interval, | |
| | kg/lactation | | Fat % | | Protein % | | LS-SCC | | days | |
| | Ctrol | FAA¹ | Ctrol | FAA | Ctrol | FAA | Ctrol | FAA | Ctrol | FAA |
| Heifer | 9024 | 10220 | 4.50 | 4.50 | 3.24 | 3.21 | 2.85 | 3.51 | 142 | 108 |
| Mature | 9835 | 10173 | 4.26 | 4.10 | 3.36 | 3.28 | 4.32 | 4.97 | 133 | 124 |
| H + M | 9429 | 10197 | 4.38 | 4.80 | 3.80 | 3.24 | 3.58 | 4.24 | 139 | 114 |

| | | | | | |
|---|---|---|---|---|---|
| Difference | 767 | 0.08 | 0.06 | 0.66 | 24.7 |
| P | <0.01 | >0.10 | >0.10 | <0.05 | −0.11 |

¹FAA = Feed Additive A

### CONCLUSIONS

The field trial appraisal concluded an average milk production of over 9400 kg/cow (4.38% fat and 3.30% protein) for a 305-day lactation. Somatic Cell Count was rather high, especially for cows with more than one parturition, which obtained a lineal index (Li-SCC) of 4.0. The calving to pregnancy intervals were also a bit off optimal levels, being calculated as some 139 days and possibly complicated with IBR infection detected on the farm.

Supplementing the diet with Feed Additive A resulted in a highly significant (P<0.01) improvement in the average milk yield (8.1% or 767 extra kg of milk per cow/lactation), together with a slight, non significant reduction on the fat and protein content to 4.30% and 3.24% respectively. The cows on the Feed Additive A group started the experiment with a lineal index of somatic cells 0.7 points higher than the control cows, this factor being a random effect exclusively. The differences in somatic cell count were stable throughout the experiment and it is concluded that Feed Additive A did not influenced this parameter. Finally, Feed Additive A caused a statistically significant (P=0.11) decrease of the calving-to-pregnancy interval, by 25 days.

The economical appraisal of this, experiment, with a base milk price of US$0.258/1; calf value at US$172.20 and excluding the product cost, is positive for the Feed Additive A-fed cows by more than US$233 per cow and lactation.

### LITERATURE REFERENCES

Akin, D. E., “Evaluation by electron microscopy and anaerobic culture of types of rumen bacteria associated with digestion of forage cell walls,” Appl. Environ. Microbiol 39:242 (1980).

Baumont, R., “Palatabilite et comportement alimentaire chez les ruminants,” INRA Prod. Anim. 9(5): 349 (1996).

Beauchemin, K. A. et al., “Fibrolytic enzymes increase fiber digestibility and growth rate of steers fed dry forages,” Can. J Anim. Sci. 75:641-644 (1995).

Castanon et al., “Effects of the surfactant Tween 80 on enzymatic hydrolysis of newspaper,” Biotechnol. & Bioeng. 23:1365 (1981).

Cervantes, A. et al., “Effects of nicotinamide on milk composition and production in dairy cows fed supplemental fat,” J Dairy Sci. 79:105 (1996).

Cheng et al., “Microbial ecology and physiology of feed degradation within the rumen,” in Physiological aspects of digestion and metabolism in ruminants: Proceedings of the seventh international symposium on ruminant physiology, Tsuda, Ed., 1991.

Esslemont, R. J. et al., “The incidence and costs of diseases in dairy herds.” DAISY report n° 2. DAISY—The Dairy Information System, University of Reading, United Kingdom, pp. 27 (1992).

Feng, P. et al., “Effect of enzyme additives on in situ and in vitro degradation of mature cool-season grass forage,” J. Anim. Sci. 70 (Suppl. 1): 309 (1992).

Forsberg, “Some Effects of Arsenic on the Rumen Microflora; An In Vitro Study,” Can. J Microbiol. 24:36 (1978).

Fronk, T. J., et al., “Effect of dry period overconditioning on subsequent metabolic disorders and performance of dairy cows,” J. Dairy Sci. 62:1804 (1980).

Goering et al., “Forage fiber analysis,” Agric. Handbook No. 379, p. 12 (1970).

Griffin et al., “Surface Active Agents,” in Handbook of Food Additives. 2^{nd} Ed., T. E. Furia, Ed., CRC Press, New York, N.Y., p 397 et seq. (1972).

Kamande, G. M. et al., “Effects of Tween 60 and Tween 80 on protease activity, thiol group reactivity, protein adsorption, and cellulose degradation by rumen microbial enzymes,” J. Dairy Sci., 83:536 (2000).

Jaster, E. A. et al., “Feeding supplemental niacin for milk production in six dairy herds,” J. Dairy Sci. 63:1737 (1983).

Jouany, J. P, “Methods of manipulating the microbial metabolism in the rumen,” Ann. Zootech. 43:49-62 (1994).

Kamande, G. M. et al., “Effect of detergents on in vitro proteolytic activity,” Proc. VII World Conference on Animal Production, Edmonton, AB. 2:62 (1993).

Littell, R. C. et al., “SAS System for Mixed Models,” Cary, N.C., SAS Institute Inc (1996).

Lundeen, T., “Mastitis management: monitoring SCC reduces mastitis incidence,” Feedstuffs January 8: 9 (2001).

Mahadevan et al., “Preparation of protease from mixed rumen microorganisms and its use for the in vitro determination of true protein in feedstuffs,” Can. J Anim. Sci. 67:55 (1987).

McAllister, T. A. et al., “Effect of a surfactant and exogenous enzymes on digestibility of feed and on growth performance and carcass traits of lambs,” J. Anim. Sci. 80:35 (2000).

Muller, L. D. et al., “Supplemental niacin for lactating cows during summer feeding,” J. Dairy Sci. 69:1416 (1986).

NRC. Nutrient requirements of dairy cattle. 6th revised edition. National Academy Press. Washington, D.C., pp. 47 (1989).

NRC. Nutrient requirements of dairy cattle. 7th revised edition. National Academy Press, Washington, D.C., pp: 170 (2001).

Parkinson and Allen, “A wet oxidation procedure suitable for the determination of nitrogen and mineral nutrients in biological materials,” Comm. Soil Sci. Plant Anal. 6:1 (1975).

Perry, T. W. et al., “Effects of supplemental enzymes on nitrogen balance, digestibility of energy and nutrients and on growth and feed efficiency of cattle,” J. Anim. Sci. 25:760-764 (1966).

Piva, G. et al, “Probiotic effect of essential oils in animal feeding,” Microbiologie-aliments-nutrition 9:161 (1991).

Rosen, “A Modified Colorimetric Analysis For Amino Acids,” Arch. Biochim. Biophys. 67:10 (1957).

Sasago et al., “Determination of sulfhydryl and disulfide groups in milk by p-chloromercuribenzoate-diathizonemethod,” J. Dairy Sci. 46:1348-1351 (1963).

Shelford, J. A. et al., “Enzyme enhancers: the key to unlocking the energy from feed,” Advances in Dairy Technology, Western Canadian Dairy Seminar, University of Alberta, Edmonton, AB. 8:269-275 (1996).

Smith et al., “Measurement of protein using bicinchonic acid,” Anal. Biochem. 150:76 (1984).

Svozil, B. et al., “Application of a cellulolytic preparation in nutrition of lambs,” Sbor. Ved. Praci. VUVZ Prhrelice 22:69-78 (1989).

Uden et al., “Investigation of chromium, cerium and cobalt as markers in digesta: Rate of Passage studies,” J. Sci. of Food and Agriculture 31:625-632 (1980).

Van Nevel, C. J. et al., “Manipulation of rumen fermentation,” In: The Rumen Microbial Ecosystem. Ed. P. N. Hobson. Elsevier Applied Science London. Pp. 387 (1988).

The embodiments of the invention in which an exclusive property or privilege is claimed are defined as follows:

1. A feed additive for ruminant animals comprising a sufficient amount of a nonionic surfactant to enhance the utilization of a feedstuff by the animal.

2. A feed additive of claim 1 which further comprises a sufficient amount of an antioxidant agent to enhance the oxidative stability of the nonionic surfactant.

3. A feed additive of claim 2 wherein the nonionic surfactant and the antioxidant agent are coated on a particulate carrier.

4. A feed additive of claim 1 wherein the nonionic surfactant is selected from the group consisting of polyoxyethylenesorbitan monooleate, polyoxyethylenesorbitan trioleate, polyoxyethylenesorbitan monostearate, alkyltrimethylammonium bromides, dodecyltrimethylammonium bromide, hexadecyltrimethylammonium bromide, mixed alkyltrimethylammonium bromide, tetradecyltrimethylammonium bromide, benzalkonium chloride, benzethonium chloride, benzyldimethyldodecylammonium bromide, benzyldimethylhexadecylammonium bromide, benzyltrimethylammonium chloride, benzyltrimethylammonium methoxide, cetylpyridinium bromide, cetylpyridinium chloride, cetyltributylphosphonium bromide, cetyltrimethylammonium bromide, decamethonium bromide, dimethyldioctadecylammonium bromide, methylbenzethonium chloride, methyl mixed trialkyl ammonium chloride, methyltrioctylammonium chloride, n,n′,mb′-polyethylene(10)-n-tallow-1,3-diamino-propane and 4-picoline dodecyl sulfate.

5. A feed additive of claim 4 wherein the nonionic surfactant is selected from the group consisting of polyoxyethylenesorbitan monooleate and polyoxyethylenesorbitan trioleate.

6. A feed additive of claim 3 wherein the nonionic surfactant comprises from about 10% to about 70% (wt/wt) of surfactant based on the combined weight of the particulate carrier substrate and coating.

7. A feed additive of claim 6 wherein the nonionic surfactant comprises from about 40% to about 60% (wt/wt) of surfactant based on the combined weight of the particulate carrier substrate and coating.

8. A feed additive of claim 2 wherein the antioxidant agent is selected from the group consisting of butylated hydroxyanisole (BHA), butylated hydroxytoluene (BHT), ethoxyquin, propyl gallate, tertiary butyl hydroquinone (TBHQ) and tocopherols.

9. A feed additive of claim 3 wherein the antioxidant agent is present in an amount from about 100 to about 2000 ppm based on the surfactant employed in the coating.

10. A feed additive of claim 3 wherein the solid particulate carrier is selected from the group consisting of celite, diatomaceous earth and silica

11. A feed additive of claim 1 which further comprises at least one digestion enhancing agent.

12. A feed additive of claim 11 wherein the at least one digestion enhancing agent is a lactic acid bacteria inoculum.

13. A feed additive of claim 11 wherein the at least one digestion enhancing agent is monensin.

14. A method of enhancing feed utilization efficiency in a ruminant animal, comprising adding to the feed of the animal a sufficient amount of a feed additive to enhance the utilization of the feed by the animal, wherein the feed additive comprises a nonionic surfactant.

15. A method of claim 14 wherein the fee additive, further comprises and a sufficient amount of an antioxidant agent to enhance the oxidative stability of the nonionic surfactant.

16. A method of claim 15 wherein the nonionic surfactant and the antioxidant agent are coated on a particulate carrier substrate.

17. A method of claim 14 wherein the nonionic surfactant is selected from the group consisting of polyoxyethylenesorbitan monooleate, polyoxyethylenesorbitan trioleate, polyoxyethylenesorbitan monostearate, alkyltrimethylammonium bromides, dodecyltrimethylammonium bromide, hexadecyltrimethylammonium bromide, mixed alkyltrimethylammonium bromide, tetradecyltrimethylammonium bromide, benzalkonium chloride, benzethonium chloride, benzyldimethyldodecylammonium bromide, benzyldimethylhexadecylammonium bromide, benzyltrimethylammonium chloride, benzyltrimethylammonium methoxide, cetylpyridinium bromide, cetylpyridinium chloride, cetyltributylphosphonium bromide, cetyltrimethylammonium bromide, decamethonium bromide, dimethyldioctadecylammonium bromide, methylbenzethonium chloride, methyl mixed trialkyl ammonium chloride, methyltrioctylammonium chloride, n,n′,mb′-polyethylene(10)-n-tallow-1,3-diamino-propane and 4-picoline dodecyl sulfate.

18. A method of claim 14 wherein the nonionic surfactant is selected from the group consisting of polyoxyethylenesorbitan monooleate and polyoxyethylenesorbitan trioleate.

19. A method of claim 14 wherein the nonionic surfactant comprises from about 0.01 to 1% (w/w) of the dry weight of the feed.

20. A method of claim 19 wherein the nonionic surfactant comprises from about 0.01 to 0.3% (w/w) of the dry weight of the feed.

21. A method of claim 15 wherein the antioxidant agent is selected from the group consisting of butylated hydroxyanisole (BHA), butylated hydroxytoluene (BHT), ethoxyquin, propyl gallate, tertiary butyl hydroquinone (TBHQ) and tocopherols.

22. A method of claim 16 wherein the antioxidant agent is present in an amount from about 100 to about 2000 ppm based on the surfactant employed in the coating.

23. A method of claim 16 wherein the particulate carrier substrate is selected from the group consisting of celite, diatomaceous earth and silica

24. A method of claim 14 which further comprises adding at least one digestion enhancing agent to the feed.

25. A method of claim 24 wherein the at least one digestion enhancing agent is a lactic acid bacteria inoculum.

26. A method of claim 24 wherein the at least one digestion enhancing agent is monensin.
